(19) United States
(12) Patent Application Publication
(10) Pub. No.: US 2026/0122107 A1
(43) Pub. Date: Apr. 30, 2026

(54) MACHINE LEARNING ARCHITECTURE FOR MALICIOUS DOMAIN DETECTION AND PHISHING PREVENTION

(71) Applicant: CardWare, Inc., Austin, TX (US)

(72) Inventors: Jiuzhen Pan, Pflugerville, TX (US); David Wyatt, Austin, TX (US)

(73) Assignee: CardWare, Inc., Austin, TX (US)

(21) Appl. No.: 19/369,059

(22) Filed: Oct. 24, 2025

Related U.S. Application Data
(60) Provisional application No. 63/711,662, filed on Oct. 24, 2024.

(51) Int. Cl. H04L 9/40

(52) U.S. Cl. CPC H04L 63/1483; H04L 63/1425

(57) ABSTRACT

Presented are apparatus, systems and methods for more secure online interactions from computing devices, including protections of sensitive identity, personal, employer, membership, financial and payments information; from the increasing waves of hacking, and relentless bombardment of phishing attacks; with ever more sophisticated social-engineering, which are increasingly indistinguishable from interactions with a genuine online connection.

In one example, the computing device can store a data structure in a first application, the data structure comprising a set of sensitive-attribute data, and an identification of a plurality of predefined or otherwise known hosts, from a list of known remote hosts. The computing-device/local-host can execute a second application to locally render a remote internet resource, such as a web page, which may additionally request the input of one or more sensitive-attribute data entry fields.

Responsive to receiving a uniform resource identifier (URI) (from an eMail, Text, scanned QR code, Hyperlink, Browser App or other), the computing device executes a first application to identify and analyze the URI, generate a plurality of first features comprising an identity of a remote host of the web-site page, compare the identity of the remote host to the identification of the plurality of known remote hosts, execute a heuristic algorithm or machine learning model, on the local host, to generate a source and content risk-score, of the remote host and the web page it conveys. The execution therebefore described can thus aid the computing device to more intelligently decide to: permit, restrict, or modify data generation methods in an auto-population entry of the one or more sensitive-attribute data entry fields, including but not limited to: selecting a payment information generation method for such data fields, based on risk analysis of said uniform resource identifier. This embodiment of the present disclosure can improve the ability of said computing device and said device user to more-immediately and objectively: identify, avoid, or manage; phishing and hacking attacks, versus those from legitimate or reputationally-sound remote hosts.

### CROSS-REFERENCE TO RELATED APPLICATIONS

This application claims the benefit of priority to U.S. Provisional Patent Application No. 63/771,662, filed Oct. 24, 2025, the entirety of which is incorporated by reference herein. The application incorporates by reference U.S. patent application Ser. No. 17/716,942, filed Apr. 8, 2022, which claims the benefit of priority as a continuation application to U.S. patent application Ser. No. 16/854,829, filed Apr. 21, 2020, which claims the benefit of priority as a continuation application to U.S. patent application Ser. No. 16/025,829, filed Jul. 2, 2018, which claims the benefit of priority as a continuation application to U.S. patent application Ser. No. 15/250,698, filed Aug. 29, 2016, which claims the benefit of priority as a continuation to U.S. patent application Ser. No. 14/680,946, filed Apr. 7, 2015, which claims the benefit of priority as a continuation to U.S. patent application Ser. No. 14/217,261, filed Mar. 17, 2014, which claims the benefit of priority of U.S. Provisional Patent No. 61/794,891, filed Mar. 15, 2013, the entirety of each of which is incorporated by reference herein.

### BACKGROUND

As described by Gallup Polls, such as according to a previous publication at news.gallup.com/poll/544643/scams-relatively-common-anxiety-inducing-americans.aspx, top crimes most often worried about by Americans in 2023 were: a) credit card, financial and identity information theft, b) computer hacking, phishing scams & financial attacks. The importance of addressing these issues together, sooner rather than later, is demonstrated by the fact these two crimes have consistently remained the top two crimes on Gallup's US polls for over a decade, as evidenced by further publications such as CNP Fraud, www.insiderintelligence.com/content/card-not-present-fraud-payment.

Over the last decade, the type of hacking attacks has evolved from a smaller number of large corporate data-breaches (e.g., Target), to more-widespread and personalized attacks. In particular, online (Card Not Present, aka “CNP”) payment card fraud exploded roughly 400% becoming the number one crime concern during the pandemic, and a problem worth $10 billion in losses per year (just in the US) by 2023. Some illustrative examples of such trends have been provided at various locations, such as www.insiderintelligence.com/content/card-not-present-fraud-payment and news.gallup.com/poll/357116/crime-fears-rebound-lull-during-2020-lockdowns.aspx. Although the availability of online shopping became more important, improving the security of online payments without onerous impact to convenience may be addressed according to more fundamental problems of sensitive information (e.g. financial card numbers, name, email, social, personal information, membership, etc.).

Historically, card payment information has comprised fixed numbers, whether printed on the card, in the magnetic-stripe, or newer EMV chip & NFC tap cards, the core set of payment info has not changed significantly since first introduced in the 1950's. By ISO/IEC 7811/7812/7813 and EMV standards, payment card numbers include the CHN (Card-Account Holder Name), fixed numbers PAN (Primary Account Number), and EXP (Expiration Date). Additionally, by per-Issuer based proprietary schemes, a CSC/CVV2/CSID (Card Security Code, or Card Validation Value number two) may be imprinted on a card and not in the magnetic-stripe, and a CVV1 (Card Validation Value number one) which is in the magnetic-stripe but not imprinted on the card.

With the introduction of EMV “dip-to-pay” Chip Cards (using the ISO7816 smart card contacts) and EMV NFC “tap-to-pay” (using the ISO14443 near-field communications interface), the card performs additional cryptographic exchanges to validate the physical card is genuine (not a readily duplicatable via counterfeit as was the case with magnetic-stripe cards) in a Card-Present (“CP”) scenario, and this can include an additional dynamically generated card validation values (e.g. CVV3)—none of which are presented to the user nor usable in an online transaction.

However, unlike the CP transactions which have now become more robust through chip and NFC standards, the core set of information used in a CNP online purchase transaction, may include intercepted or stolen fixed information, specifically the: CHN, PAN, EXP, CSC and potentially billing zip-code. No matter how carefully this static information is hidden or encrypted, once fixed information is stolen (e.g., leaked, breached, copied, or skimmed), it is readily re-usable in fraudulent transactions until the card account numbers themselves are invalided by the issuer, e.g., replaced with a new set of numbers on a new card. In the era of internet online shopping, payment card replacement has become onerous (taking an average of two to four weeks) for cardholders to replace the fixed set of payment numbers everywhere the card information had been stored such as in Card-on-File at an online merchant. This is not including time spent negotiating with an issuer, bank, or merchant for the return of stolen funds or goods. As for the merchant, the loss-value can be two-fold, once for the value of the goods that were fraudulently purchased and delivered, and again for the “chargeback” of funds denied by payment authority.

Identifiers, Locators & Numbers: Network connected devices typically provide user interface instances including entry fields and correspond to a host remote from the device. For example, the remote host can be or include a host for a web page server or a host of a resource for a mobile application, or may be a source of an email, text message, or other network communication. In some cases, the network connected devices are configured to automatically populate the entry fields with a name, email address, or so forth. In some cases, a malicious actor operating a host remote from the device may spoof a legitimate site to encourage a user to provide various attributes (e.g., name, address, password, crypto-wallet key, credit card details, etc.). For example, the remote host can provide a link to an imposter website which exhibits slight typographical variation from a trusted web site or includes a different top-level domain from a trusted site. In some cases, the remote host can relay communications between the device and a legitimate host. The network connected device can, when presenting a web page, email message, text message, or screen, prompt a user to provide attributes to the host, as may be conveyed to a host operated by a malicious operator.

### SUMMARY

Provided herein is an advanced system designed to detect and analyze potentially malicious phishing sites from internet sites contained in browser uniform resource locators (URLs), emails and text message content. The present disclosure may aid in the assessment of potential risks, and provide insights to those risks, before giving out sensitive information according to an execution of a secure communications application. The secure communications application may be available as a part of a standalone wallet app or a web-applet (e.g., a browser plug-in), or other application which can load, display, or open URI (e.g., an email application that can conveys content from the internet and provide actionable (“clickable”) links, such as could open a browser). The secure communications application may be integrated into any app or service as part of an API service exposed from a (licensed) source, such as a Software Development Kit (SDK).

The presently disclosed systems and methods can take an internet browser URL and domain, email or text message, and any embedded content-attachments therein, as input, and perform a comprehensive analysis, returning a score (sometimes referred to as a safety, risk score, aggregated score, etc.) along with a detailed security assessment, and then aid the user in deciding how to proceed, or to provide the user with options according to the risk, or whether to not provide any assistance at all and to decline complicity. This solution can a) assist in deciding whether or not the internet-site arrived-at contains security risks and provides insights, b) choose specific course of action based on those risks & insights, and c) declines to perform some capability, such as the auto-population of fields, the generation of various attributes (e.g., credentials, identity, payment info) or so forth.

Some of the illustrative, nonlimiting examples provided herein refer to: A) an integration of the secure communications application with a web application configured to manage credentials, such as may further integrate with a payment system such as Card+ Pay, Card+ Cash, PayPal, ApplePay, GooglePay, WeChatPay or AliPay (exemplary QR code based payment systems, popular in China), UPI (Unified Payments Interface, an exemplary QR-code based open payment system, popular in India), and Digital Currencies (including: Central Bank Digital Currency (CBDC), BitCoin, or other crypto-currencies); B) an integration of the secure communications application with an identity theft situation in which confidential/sensitive/personal information may be elicited, such as that received via text message or email; C) an integration of the secure communications of an application with the O/S (e.g. opening a received URI in one application results in the O/S opening a separate application on recipient machine), or another application, game, or web browser (e.g. opening another web-page, auto-population of credentials, addresses, emails, phone numbers, or private keys); D) an integration in a messaging application which can receive URI attachments (such as an eMail client application, instant messaging application, text messaging application, or group collaboration application), and analyze: the sender credentials, the attached URI, and it's referred action. The secure communications application can thereupon decide a course of action (e.g. do or don't launch the referred web-page, do or don't open the referred payment application), or provide user warnings based on the risk assessment; E) an integration into a software application which includes an access control via a security challenge or an entry of credentials (such as a username, password, passcode, or PIN).

In some aspects, the techniques described herein relate to a method of secure communication including: storing, by one or more processors of a local host, a data structure in a first application, the data structure including a plurality of known remote hosts and a machine learned set of a weighted connections between common features and identifications of known remote hosts (e.g., the plurality of known remote hosts); executing, by the one or more processors, a second application to present a web page including one or more entry fields; and executing, by the one or more processors, the first application to: identify, by one or more processors, a uniform resource identifier (URI); generate, by the one or more processors using the URI, a plurality of first features, the plurality of first features including an identity of a remote host of the web page; compare, by the one or more processors, the identity of the remote host to the identifications of the plurality of known remote hosts, to determine whether the remote host matches one of the features or identifications of the plurality of known remote hosts (e.g., a first remote host of the plurality of known remote hosts); responsive to determining a degree of similarity to which the remote host matches a first of the plurality of known remote hosts, infer, by the one or more processors from the machine learned set, using the plurality of first features to generate a risk score of the remote host of the web page, using a machine learning model trained based on: first tagged web pages for spoofed sites; second tagged web pages for authentic sites; and a set of labeled attributes of remote hosts or web pages; determine, based on the risk score, an appropriate method of a generation for a dynamically generated data element of said one or more entry fields and combine said dynamically generated data element with other static data elements, into a combined data structure capable of auto-population; and restrict (e.g., based on the risk score), by the one or more processors, based on the risk score, an auto-population with said combined data structure of the one or more entry fields with the set of labeled attributes from the first application based on the risk score.

In some aspects, the techniques described herein relate to a method, wherein the remote host matches at least one of the plurality of known hosts, the known remote hosts being ranked in known risk degrees from low risk to high risk, and further including: ranking, by the one or more processors, a list of credentials associated with the plurality of known remote hosts; selecting, by the one or more processors, a highest ranked one of the list of credentials; and generating, by the one or more processors, a symbolic-token to convey the selected one of the list of credentials to the local host.

In some aspects, the techniques described herein relate to a method, wherein: the list of credentials corresponds to a list of stored accounts; and the ranking of the list of credentials is based on an incentive of a merchant associated with the remote host. In some aspects, the techniques described herein relate to a method, wherein an authorization level of the symbolic-token is based on the risk score. In some aspects, the techniques described herein relate to a method, further including: establishing, by the one or more processors, a communicative connection with a plurality of remote resources; generating, by the one or more processors, a plurality of second features of the remote host responsive to information retrieved from the plurality of remote resources; and generating, by the one or more processors, a plurality of third features of content served by the remote host, wherein the restriction is based on the plurality of second features or the plurality of third features.

In some aspects, the techniques described herein relate to a method, wherein generating the plurality of third features includes: identifying, by the one or more processors, an image file served by the remote host; identifying, by the one or more processors, textual content of the image file; and determining, by the one or more processors based on the textual content, that the remote host is spoofing or otherwise illegitimately misrepresenting itself as one of the known hosts, wherein the restriction is configured to present, at the local host, at least one of a set of responses selected from the group comprising one or more of: a warning dialog rendered in a user interface of said local host, a selection of an information generation method of data prior to a data entry operation, a prevention of an automated entry of the data into the one or more entry fields, and a prevention of all entries of data into the one or more entry fields. In some aspects, the techniques described herein relate to a method, further including: generating a second risk score based on the second plurality of features and the third plurality of features, wherein the restriction is based on a comparison of the risk score to a threshold; and presenting a visual indication of the second risk score.

In some aspects, the techniques described herein relate to a method, wherein the plurality of first features further includes: an indication of a secure connection with the remote host via a secure transport protocol. In some aspects, the techniques described herein relate to a method, wherein the restriction includes: disabling automatic completion of the one or more entry fields by the local host. In some aspects, the techniques described herein relate to a method, wherein the restriction includes: masking a display of the one or more entry fields with an overlay indicating a risk score associated with the remote host.

In some aspects, the techniques described herein relate to a method, wherein: the first application is a microservice; and the second application is one of a browser or a mobile application, the microservice configured to receive the URI from the second application. In some aspects, the techniques described herein relate to a device for secure communications including: an interface connecting a local host to the internet; and one of more processors coupled with memory and configured to: store, retrieve, and generate sensitive data elements into a combined data structure in a first application, the sensitive data elements including at least one data element with attributes selected from a group of sensitive data attributes comprising one or more of: personal information, an employer information, an identification, an entitlement, a financial information, payment information, an access credential, a username; a password, or a membership information; establish a connection with a remote host via said interface; execute a second application to present a web page received via said interface, the interface configurable to receive sensitive data via at least one data-entry field; detect a uniform resource identifier (URI) for a remote host potentially configured to receive said data from the at least one data-entry fields; generate a set of features based on the URI, each element of the set of features based on at least one of: the URI, the remote host, or content received from the remote host; determine, using a machine learning model, a risk score based on: said URI, said remote host, said content, and said set of features; determine, based on the risk score, a type of data generation of at least a portion of said sensitive data, for population in the at least one data-entry field; based on said risk score, perform an action to-populate or decline to populate, at the local host, the entry of the at least one data-entry field with said combined data structure; and present, via a user interface rendered on said device, a message conveying at least one information element selected from the group comprising one or more of: the action performed, a recommendation of an action to be performed, the risk score, and a symbolic representation of the action, the recommendation, or the risk score.

In some aspects, the techniques described herein relate to a device, wherein the device is configured to determine: a first plurality of features of the set of features based on a unique remote host identifier of a URI; a second plurality of features of the set of features based on information retrieved from a plurality of remote resources of the remote host; and a third plurality of features of the set of features based on the content served by the remote host, wherein the risk score is based on the first, second, and third pluralities of features.

In some aspects, the techniques described herein relate to a device, wherein the device is configured to: generate the risk score based on the second plurality of features and the third plurality of features; present a visual indication of the risk score; and generate a symbolic-token having an authorization level based on the risk score.

In some aspects, the techniques described herein relate to a device, wherein the data structure includes a plurality of known remote hosts and the device is configured to: determine whether the remote host matches one of a plurality of known remote hosts; cause to be populated, responsive to the determination of the match, the at least one data-entry field; and generate the set of features responsive to a determination that the remote host does not match any of the plurality of known remote hosts.

In some aspects, the techniques described herein relate to a device, wherein the device is configured to: rank a list of credentials corresponding to a list of stored accounts associated with the remote host; select a highest ranked one of the credentials; and automatically populate the at least one data-entry field with a symbolic-token to convey the selected one of the credentials to the remote host.

In some aspects, the techniques described herein relate to a device, wherein the plurality of known remote hosts includes an approve list and a deny list, wherein the one or more processors are configured to: determine whether the remote host matches the one of the known remote hosts of the deny list; and inhibit, based on the match to the deny list, the population of the at least one data-entry field based on the determination that the remote host matches the one of the known hosts of the deny list.

In some aspects, the techniques described herein relate to a device, wherein the device is configured to operate in an online mode and a local mode, wherein: when operating in the online mode, the plurality of features include information retrieved from a plurality of remote resources, the information including: a domain registration score for domain registration data, a domain name score for domain name system data, a security certificate score for the certificate securing online data communication, and a content score for a portion of the content disposed proximal to the at least one data-entry field, wherein the content score is predicted according to execution of a machine learning model trained with tagged instances of web pages for spoofed sites and authentic sites.

In some aspects, the techniques described herein relate to a computer-readable medium having stored thereon instructions that, when executed by a processor, cause the processor to perform a method including: instantiating a web browser configured to access at least one data structure selected from a group of sensitive-attribute data structures, the group comprising one or more of: personal information, an identification, financial information, payment information, an access credential, a username, a password, of a membership information; and presenting web pages including one or more data-entry fields on a user device based on a receipt of a uniform resource identifier (URI), wherein the web browser is configured to: generate, using the URI, a plurality of first features, the plurality of first features including an identity of a remote host of the web page; compare the identity of the remote host to a plurality of known remote hosts, to identify whether the remote host matches one of a first subset of trusted remote hosts of the known remote hosts or one of a second subset of untrusted hosts of the known remote hosts; restrict, based on the identification of the match between the remote host and one of the second subset of untrusted hosts, an auto-population of the one or more data-entry fields with one or more of the group of sensitive-attributes; and permit, based on the identification of the match between the remote host and one of the subset of trusted hosts, an auto-population of the one or more data-entry fields with one or more of the group of sensitive-attributes.

In some aspects, the techniques described herein relate to a computer-readable medium, wherein the instructions include instructions to: establish a secure connection with a second remote host, the second remote host disposed remote from the computer-readable medium; generate network traffic to a third remote host, the third remote host configured to identify a source of the network traffic; determine a presence or an absence of an intermediary disposed between the user device and the third host based on tuple information of the network traffic; and transmit, to the second remote host, first data based on stored user credentials and the absence of the intermediary.

In some aspects, the techniques described herein relate to a method of secure communication including storing and analyzing, by one or more processors, a data structure in a first application, the data structure including a set of attributes and identifications of a plurality of predefined hosts (used herein synonymously with “known hosts”, and “known remote hosts”); executing, by the one or more processors, a second application to present a web page including one or more entry fields; and executing, by the one or more processors, the first application to identify, by one or more processors, a uniform resource identifier (URI); generate, by the one or more processors, using the uniform resource identifier, a plurality of first features, the plurality of first features including an identity of a host of the web page; compare, by the one or more processors, the identity of the host to the identification of the plurality of known hosts, to determine whether the host matches one of the identifications of the plurality of known hosts; responsive to determining the host does not match any of the identifications of the plurality of predefined hosts, execute, by the one or more processors, a machine learning model using the plurality of first features to generate a content score of the web page, the machine learning model trained based on first tagged web pages for spoofed sites and second tagged web pages for authentic sites; and restrict, by the one or more processors, based on the content score, the auto-fill, automatic-complete, or an auto-population of the one or more entry fields with the set of attributes from the first application based on the content score.

In some embodiments, the host matches a first of the predefined hosts, and further including ranking, by the one or more processors, a list of credentials associated with the first of the predefined hosts; selecting, by the one or more processors, a highest ranked one of the list of credentials; and generating, by the one or more processors, a symbolic token to convey the selected one of the list of credentials to the host.

In some embodiments, the list of credentials corresponds to a list of stored accounts; and the ranking of the list of credentials is based on an incentive of a merchant associated with the host. In some embodiments, an authorization level of the symbolic token is based on a risk score. In some embodiments, the method further includes establishing, by the one or more processors, a communicative connection with a plurality of remote resources; generating, by the one or more processors, a plurality of second features of the host responsive to information retrieved from the plurality of remote resources; and generating, by the one or more processors, a plurality of third features of content served by the host, wherein the restriction is based on the plurality of second features or the plurality of third features. In some embodiments, generating the plurality of third features includes identifying, by the one or more processors, an image file served by the host; identifying, by the one or more processors, textual content of the image file; and determining, by the one or more processors based on the textual content, that the host is spoofing one of the predefined hosts, wherein the restriction is configured to prevent entry of data into the one or more entry fields.

In some embodiments, the method further includes generating a risk score based on the second plurality of features and the third plurality of features, wherein the restriction is based on a comparison of the risk score to a threshold; and presenting a visual indication of the risk score. In some embodiments, the plurality of first features further includes an indication of a secure connection with the host via a transport security protocol.

In some embodiments, the restriction includes disabling automatic completion of the one or more entry fields. In some embodiments, the restriction includes masking a display of the one or more entry fields with an overlay indicating a risk score associated with the host. In some embodiments, the first application is a microservice; and the second application is one of a browser or a mobile application, the microservice configured to receive the URI from the second application.

In some aspects, the techniques described herein relate to a device for secure communications including a wireless interface; and one of more processors coupled with memory and configured to store a data structure in a first application, the data structure including a set of attributes; execute a second application to present a web page including one or more entry fields; establish a connection with a host via the wireless interface; detect a unique identifier for a host configured to receive data from the one or more entry fields; generate a plurality of features based on the unique identifier, each of the plurality of features based on at least one of the unique identifier, the host, or content of the web page; execute a machine learning model to determine a risk score based on the plurality of features; and restrict, based on the risk score, a population of the one or more entry fields.

In some embodiments, the device is configured to determine a first plurality of the plurality of features based on a uniform resource identifier of the unique identifier; a second plurality of the plurality of features based on information retrieved from a plurality of remote resources; and a third plurality of the plurality of features based on the content served by the host, wherein the risk score is based on the first, second, and third pluralities of the plurality of features. In some embodiments, the device is configured to generate the risk score based on the second plurality of features and the third plurality of features; present a visual indication of the risk score; and generate a symbolic token having an authorization level based on the risk score. In some embodiments, the data structure includes a plurality of predefined hosts and the device is configured to determine whether the host matches a plurality of predefined hosts; cause to be populated, responsive to a determination that the host matches one of the plurality of predefined hosts, the one or more entry fields; and generate the plurality of features responsive to a determination that the host does not match any of the plurality of predefined hosts. In some embodiments, the device is configured to rank a list of credentials corresponding to a list of stored accounts associated with the host; select a highest ranked one of the credentials; and automatically populate the entry field with a symbolic token to convey the selected one of the credentials to the host.

In some embodiments, the plurality of predefined hosts includes an approve list and a deny list, wherein the one or more processors are configured to determine whether the host matches one of the predefined hosts of the deny list; and inhibit, based on the match to the deny list, the population of the entry field based on the determination that the host matches the one of the predefined hosts of the deny list. In some embodiments, the device is configured to operate in an online mode and a local mode, wherein when operating in the online mode, the plurality of features include information retrieved from a plurality of remote resources, the information including a domain registration score for domain registration data, a domain name score for domain name system data, a security certificate score for security certificate data, and a content score for a portion of the content disposed proximal to the entry field, wherein the content score is predicted according to execution of a machine learning model trained with tagged instances of web pages for spoofed sites and authentic sites.

In particular, a machine learning model can offer an advantageous ability inferring (or more readily classifying) sites never encountered before, by using aspects of past nefarious vs good sites. As opposed to traditional software methods of growing a heuristically complex checking procedure or an infinitely-changeable ever-larger list of sites as dynamic as the internet itself. However, it also follows that where constraints dictate such feature comparisons may be better performed heuristically (whether faster, smaller, more accurately, or more simply) by an algorithm executed in software running on the processor, then other exemplary embodiments may perform all-of, or some portions-of, deriving the score in other means in addition-to, or instead of the machine learned model method. An example of such sub-portion performed heuristically, could include the step of directly searching for the specific merchant domain, from with a list of known affiliated merchants - which if found in an exact match may be operationally simpler, and obviate the need for further machine learned model analysis. Similarly, in other exemplary embodiments, the analysis of a secure web-page (https) certificate was historically performed algorithmically (e.g. by validating the certificate's cryptographic contents), and can also be done heuristically (e.g. by comparing a fingerprint of the certificate, to a list of known-certificate fingerprints), and depending on the embodiment characteristics (e.g. having a less processor-memory capability, than a full machine learning model requires) this (or other) portion(s) of the risk-score analysis may preferentially be performed algorithmically & heuristically on the local host processor, and also drive the specific choice of generating auto-fill information.

In some aspects, the techniques described herein relate to a computer-readable medium having stored thereon instructions that, when executed by a processor, cause the processor to perform a method including instantiating a web browser configured to access a data structure including a set of attributes, the attributes including a name, address, email, and phone number, and present web pages including one or more entry fields on a user device based on a receipt of a uniform resource identifier (URI), the web browser configured to generate, using the URI, a plurality of first features, the plurality of first features including an identity of a host of the web page; compare the identity of the host to a plurality of predefined hosts, to identify whether the host matches one of a first subset of trusted hosts of the predefined hosts or one of a second subset of untrusted hosts of the predefined hosts; restrict, based on the identification of the match between the host and one of the set of untrusted hosts, an auto-population of the one or more entry fields with the set of attributes; and permit, based on the identification of the match between the host and one of the set of trusted hosts, an auto-population of the one or more entry fields with the set of attributes.

In some embodiments, the instructions include instructions to establish a secure connection with a first host, the first host disposed remote from the computer-readable medium; generate network traffic to a second host, the second host configured to identify a source of the network traffic; determine a presence or an absence of an intermediary disposed between the user device and the second host based on tuple information of the network traffic; and transmit, to the first host, first data based on stored user credentials and the absence of the intermediary.

### BRIEF DESCRIPTION OF THE DRAWINGS

FIG. 1 is a block diagram for an environment including a data processing system configured for secure communications, according to some embodiments of the present disclosure.

FIG. 2 is a flow diagram for a method of secure communication, according to some embodiments of the present disclosure.

FIG. 3 is a flow diagram for another method of secure communication, according to some embodiments of the present disclosure.

FIG. 4 is a sequence diagram for determining a content score of a web page, according to some embodiments of the present disclosure.

FIG. 5 is a sequence diagram for training a machine learning model, according to some embodiments of the present disclosure.

FIG. 6 is a sequence diagram for presentation of a user interface instance, according to some embodiments of the present disclosure.

FIG. 7 is a block diagram illustrating an architecture for a computer system that can be employed to implement elements of the systems and methods described and illustrated herein.

FIGS. 8-25 depict example user interface instances of the present disclosure, according to some embodiments of the present disclosure.

### DETAILED DESCRIPTION

Web pages, which may be provided by various general purpose web browsers or mobile applications, can include entry fields to provide attributes, such as a name, address, personal identification number (PIN), payment credential, or so forth. In some circumstances, the same web browser or mobile application presenting the web page may be configured to automatically populate the entry fields, or else cause the entry fields to be presented to a user for manual entry. A host, remote from the device, can execute a form handler to process data received from the entry fields. Some remote hosts may spoof or otherwise illegitimately misrepresent a legitimate host (e.g., a service provider or merchant), and execute a form handler to receive data from entry fields. For example, a malicious host can present a webpage that is a facsimile of a well-known and trusted merchant, and execute a form handler to extract passwords, cryptographic keys, bank account numbers, or so forth. The mobile application, other web browser, or a separate application communicatively coupled therewith (e.g., an applet or browser plug in) can detect an identity of a potentially malicious host, and control the population of entry fields based thereupon.

Systems of the present disclosure can identify a potentially malicious host according to a uniform resource identifier (URI), such as an address field of a web browser or an action URI embedded in a text message, email, or application control element. However, such a URI may be impractical or impossible for a user to access, parse, compare to known hosts, or extract features to determine a risk score. However, according to the present disclosure, a system can receive the URI and determine an identity of a host based thereupon. For example, the system can extract features associated with the URI and predict a risk score based thereupon (e.g., based on a length, a presence of misspelling, or a correspondence to a predefined list of allowed or blocked hosts). In some embodiments, the system is configured to determine the risk score based on further data as may be retrieved from various remote resources, such as (secure socket layer, SSL) security certificate signatories, WHOIS data sources, or so forth. In some embodiments, the system is configured to determine the risk score based on content data of a web page or other content (e.g., email or text message content) associated with the host. Systems of the present disclosure can provide an indication of risk in addition to (or in order to) control of the population of entry fields based on the identification of the host.

The control of the population of entry fields can refer to automatically populating fields (or allowing another application to do so) or foregoing auto-population (by preventing another application from doing so). The control of the population of entry fields can refer to a presentation or non-presentation of the entry fields. For example, a system of the present disclosure can generate an overlay for a web browser or other application to prevent a user from populating an entry field, or otherwise prevent the web browser or other application from presenting the entry fields. In some embodiments, the control of the population of entry fields refers to a selection of an entry for the field. For example, the system can cause a one-time credential or amount-limited credential to be provided for an entry-fields responsive to a risk level exceeding a risk threshold. In some embodiments, the control of the population of entry fields can refer to selection of an appropriate credential for a host. For example, the system can select a credential corresponding to a payment card network authorized by the host, or select a credential corresponding to an incentive of the host (e.g., the system may select a payment card associated with an issuer offering 5% back on dining for a host identified as a restaurant).

For clarity of the disclosure, before proceeding with further description of the systems and methods provided herein, context and illustrative descriptions of various terms are provided henceforth:

Auto-Fill: Automating data-entry tasks, such as auto-filing personal, username/passwords, and financial details, have been implemented in web-browsers, word processor applications, email applications, and other user interfaces. According to such implementations, data may be securely stored in a computer, and replayed into the appropriate data entry-fields upon a user-request to auto-fill, if an authorized device user is validated by the device. However, the personal and payment information being auto-filled may be of a static nature, recalling a set of fixed numbers and re-formatting them to match the data entry field (e.g. re-formatting the known expiration date into MMYY vs MM/YYYY). Some core challenges of such systems have included a) the safe storage of (static) sensitive information, and b) the adaptability of the auto-fill algorithm to recognize and re-format to match the host data-entry fields (e.g., their encoding and arrangement).

In this disclosure, novel auto-fill functionality is provided, in which tokenized payment information can be generated on-the-fly, incorporating at least one of a viable set of limitations-in-use from a selected generation method, to represent originating accounts, containing dynamic and static portions that are intentionally difficult to store and replay. Specifically, if any portion is replayed or otherwise re-used outside of certain limitations (e.g. a limitation to not be usable more than once, for one payment), the fraudulent transaction may be readily detected and declined (e.g. for example because when re-used, it incorporates a now-out-of-sequence sequential transaction counter count), by a facility in the payment processing process. Apart from the portion of auto-fill relating to the re-formatting of the stored information, another important aspect of this disclosure is selecting varying data-fields as dynamically generated, rather than filled with different static information, according to an analysis of the host (e.g., the method of combining the static & dynamically generated data is selected for a given page-entry auto-fill based on a risk score of the page-host).

Security Checkmarks: Features to aid the user in determining if a web-site presents a privacy risk (such as IP logging, fingerprinting, cookies and other tracking techniques) can be featured in many web-browsers. Additionally, web-browsers can analyze URL's for potential interception, or malignant code. For example, symbols (such as a shield icon or position next the URL in the browser window) can present a simplified visual summary of the personal-tracking-risk assessment, for privacy or other security risks.

Anti-fraud tools: In China, the government offers a solution to check for fraud and phishing using the China Anti-Fraud Application (CAFA) which detects if the site the user is browsing-to is one of the known fraudulent and phishing sites in a government stored database, and thereupon blocks all access to the site, which is (by the government) determined to be dangerous. Importantly this is not just alerting users, or blocking the potential mis-entry of sensitive info - all access to the site is blocked. CAFA is reputed to have low-adoption rate, owing to suspicions of recording or blocking web sites for other purposes, such as non-alignment with government objectives such as accepting donation for free-speech causes, and international organizations.

In contrast, the present disclosure may be implemented without denying a user the ability to visit any web page, view any contents, or block an ability to receive messages, nor block viewing/editing/entering contents. For example, implementations of the present disclosure can instead provide a risk assessment and score, and decline device-automated population of device generated payment information by the electronic device. That is, implementations of the present disclosure simply alter/disable automated assistance, while maintaining user ability to ignore warnings and manually fill-in personal or payment information by another means.

In some embodiments (for example where the browser, bank application, or other implementation of the secure application has integrated the disclosed solution), the party responsible for the payment device (or operating system, application, or automation) can add the disclosed technology to improve user confidence, and reduce negative experiences. Such an implementation could be optionally enabled/disabled (e.g., as an optional feature). For example, the feature can be enabled when choosing a specific browser, a specific merchant, or a specific check-out method. According to some implementations, a party taking the risk for fraud (e.g. bank issued payment card), may proactively decline to provide financial information or financing, in cases of high-risk; as a feature that the user accepts when sourcing financial services from that party. In other words, some implementations of the present disclosure, as may be provided to address the phishing challenge, may be presented as a feature that does not compromise a user's freedom of choice, nor freedom of speech, but operates as an assistant agent reducing risk without diminishing the user experience, whether presented as a selectable feature, as a requirement for extending a payment authorization, or as a required safety hurdle within an application that can manage sensitive information.

Another anti-fraud tool may involve processing requests containing different codes or content received across a network to generate advice regarding fraudulent or phishing attacks that may be involved in the codes or content. Requests can include text messages, emails, social media messages, links, or QR codes. In some cases, a user can transmit such requests via a chatbot. A server that receives such requests can generate advice regarding typical fraudulent or phishing attacks. In one example, a message can include the string “I just got an email saying to share my one-time password.” In response, the server can generate a message indicating that an email requesting one-time passwords is a common phishing tactic.

However, this code or message analysis anti-fraud tool suffers from deficiencies that are addressed by the present disclosure. For example, the present disclosure may be implemented to analyze the content of specific URIs to determine whether the URIs are fraudulent or correspond to phishing attacks. Additionally, because the present disclosure may be implemented as an application or a browser web applet (e.g., an on-device application accessing a potentially fraudulent data source), implementations of the present disclosure can guide or prevent (e.g., block) auto-filling sensitive information or payment information. Additionally, in contrast to the code or message analysis anti-fraud tool, the present disclosure can alter (e.g., automatically alter) payment or sensitive information generation (e.g., tokenization with different limits).

Machine-learned phishing models: machine learning models may be used to recognize textual expressions of internet content (addresses, hosts, domains, web pages, URI's etc.). The networks of such models may be trained to associate risk levels with characteristics and features of such content (e.g. through databases of sites, manual or automated labelling). Some efforts in this area rely on text and language analysis models such as BERT; those skilled in the art will recognize that such models can be trained such that when presented with an entirely new host (URI, URL, domain, web-page host, text message, etc.), such models are able to predict a similarity to the known set of good and bad features, attributes, and domains. Such inference models may function as classification networks, and typically provide an analog representational result as output, in a scale of the degree from “good” to “bad”—(e.g., a “risk score”). Taken alone, such a “risk score” may not be actionable. For example, it may remain unclear how to operate relative to any particular risk score (e.g., 51%, 65%, 49%, or 35%). For example, the risk score may not directly relate to whether a site should be visited at all, visited in a read only mode, or if information should be provided to entry-fields of the site.

One flaw of some Machine Learning Models is that they cannot necessarily recognize the obvious unless specifically trained for that occurrence. Importantly, other factors such as non-obvious characteristic attributes may change how one assesses a host. Aspects of this disclosure address this missing aspect of the pure machine learned model, for example (but not limited to) the addition of an affiliated merchant list. In essence this can be viewed as a “known good list” of partners, which come pre-recommended, an incentive to reduce risk for consumers that come onboard their platform (e.g. they implicitly/explicitly want repeat customer business, and can contribute a higher, than other factor, weighting in the assessed risk score).

Additionally, while a pure machine-learning model approach may be sub-optimal in some respects, this disclosure addresses technical problems related to the phishing of sensitive information (e.g., financial information), and the evolution of new technology (SmartTokenization) that can mitigate data theft in different situations. The present disclosure identifies how different levels of risk can be used to select different methods of SmartTokenization, which can vary on scale between security and convenience, and thus leverage the previously inactionable risk score to more beneficially and intelligently manage risk exposure, as well as the culpability of online device in automating and aiding the supply of sensitive information to phishers, in some embodiments.

Tokenization can be implemented to address fraud from stolen payment information, by modifying the transaction process inside the merchant, so that any transacted or stored payment information is not reusable outside the merchant. This approach can be based on a cryptographic technique known as tokenization, where a unique (but not encoded or otherwise encrypted version of the) number is used in place of the actual number, and thus is not reversable back into a usable form, by anyone other than the source and intended recipient. Tokenization can be preferrable to encryption, because in the case of the latter once the encrypting key is leaked the entire database of cipher-text is reversable and can be revealed whereas in the case of tokenization the data is not generally reversable since a token generally has no mathematical relationship to the plain-text source data, nor to the method of tokenization. Historically, tokenization has been widely used to protect merchants from potential liability in a data-breaches, but did not protect a consumer, nor insulate the merchant from a fraudster using stolen consumer payment credentials before the tokenization was applied.

Another solution, addressing the continuing dependance on fixed numbers, leverages the processor of modern electronic devices to introduce limitations-of-use into dynamically-generated portions of the payment numbers, as the device is doing the payment. Such an approach is collectively referred to hereon as “SmartTokenization,” as to include the previously incorporated material of, for example, U.S. patent application Ser. No. 14/217,261 and U.S. Provisional Patent No. 61/794,891. According to some implementation of SmartTokenization, the technology retains recognizable static token portions (as well as dynamically-generated token portions) for compatibility with existing system, and for example: to identify (via the selected static token) that the payment was using the SmartTokenization technology and thus required verification (of matching dynamic portion(s)) by a card processing facility, as well as to also facilitate typical issuer and merchant-consumer processes such as refunds, keeping CoF “card-on-file” payment account information, tracking spending, rewards/loyalty, revocation and replacement, etc.

Some parts of the SmartTokenization solution that may be left up to the implementer include: selecting the specific limitation-of-use method, appropriate for the specific payment circumstances, determining whether a higher or lower risk warranted selecting one method over another, and choosing what action(s) to take based on this, in a specific transactional context. These choices could be pre-determined by the card-issuer or bank, a run-time user choice at the device, an implementation choice, or other authority policy. However, this disclosure provides various techniques as may be implemented with SmartTokenization, such as according to methods to analyze and determine risks in the communication channel of the payment transaction itself, and to choose/recommend specific limited-use payment method, and other actions to take in response to analysis.

Aspects of the present disclosure describe how a risk factor is determined. Such aspects include but not limited to: a) whether higher risk factors warrant declining the transaction altogether, or b) if medium risk factors may permit proceeding, but warrants using a safer one-time only limited-use number, or c) conversely, if a lower-risk or recognized recipient supports using a merchant-limited number (storable by the merchant, aka “card on file”) for a more convenient re-use whenever shopping at that specific merchant.

As indicated in, for example, U.S. patent application Ser. No. 15/250,698 (e.g., as claimed therein), SmartTokenization technology can be implemented to aid in the protection of more than just payments information, and can be applied to aiding a more secure use in situations such as retaining protections and limitations of use in other information including but not limited to: identity, personal, employer, membership, financial and other sensitive information. For example, where cited of a denying/changing the method of generating tokenized payment data, based on a risk score, this can similarly be applied to the generation of tokenized identity data. In an embodiment, the generation of a billing address for payment is replaced with a dynamically generated location, unique for that transaction, and the payment details generated at that moment. In another exemplary embodiment, an ID such as a driver's license has core sensitive details (number, address, gender) replaced with tokenized numbers, except birth month-year, such that it can convey only the ID holder's age, or entitlement to purchase (e.g. beverages restricted to those over 21), without necessarily compromising personally sensitive details through disclosing entitlement. And similarly to the payment tokenization examples cited herein, such a tokenization can be driven by the detected URI contents e.g. tokenizing all but age on visiting a known beverage vendor such as https://bevmo.com web-site, or scanning vendors QR code at a store location. It will be obvious to those experienced in the art, that many permutations of tokenizing sensitive information based on a detected usage, locality, and risk-score, are comprehended and possible without limitation to the specific exemplary embodiments cited.

Automation: computing devices can aid a user in performing repeated manual data-entry operations, especially when those operations require simple manual re-entry of the same data on same the computer itself (also known as Robotic Process Automation, or RPA). However, some data may be considered private or sensitive, and may be withheld from such automation. For example, some standards or legislation indicate that the sensitive data such as payment card numbers and security codes should be withheld (e.g., FACTA, the Fair and Accurate Credit Transactions Act of 2003; and PCI DSS, the Payment Card Industry, Data Security Standards). Validation of a sender identity, authorization, and collection of user consent can prove important, and international legislation (e.g. GDPR) has evolved to address such steps (e.g., when storing, or passing information over public networks such as the internet).

Technologies (such as touch-sensor biometrics) have evolved to more conveniently a) confirm an authorized device's user is operating the device and b) acquire their consent, for example a touch sensor array that can sense a recognized touch, a gesture, or a double-press action, as described in SmartTokenization. Thus, technology has aided quickly authorizing the automated entry of sensitive data in a combined step, sometimes with less time for careful consideration.

Some examples of personal and sensitive information, include the online entry of name, address, email, social security, driver's license ID, birthday, payment card details, username, password, PIN, passcode, access credentials, loyalty/reward accounts, online account, merchant accounts, membership, social media callsign/handle/hashtag, entitlement (e.g., senior discount or student status), relationships, ethnicity, disability, immigration or residency status, education, credentials and other sensitive information, which a person may reasonably wish to disclose and selectively control who receives, as well as that which could cause harm (e.g., personal, financial, security, public, social) to the person, employer, or related parties, if leaked or misused. For the purposes of this disclosure, the aforementioned are non-limiting examples, and may be referred to as any of: personal, sensitive, credentials, payment or financial information, without limiting effect.

For a username, password, billing address, and payment card number that rarely changes, the task of entering this information was ripe for automation assistance. Such data can be auto-filled after a simple user-authorization whether by passcode/PIN, fingerprint, face-id, biometric, two or three factor authentication, or other methods. However, while many users have come to rely on computer assistance (such as web-browser autofill of credit card numbers) to reduce wasted time, the time thus regained has not necessarily been re-applied in making better decisions or even applying equally cautious judgement, to the entry-process, or to whom the sensitive information is being given-to. On the contrary, the speed at which the user can proceed through this process is sometimes without thought, and is reduced to just one or two clicks, and this can contribute to the problem in phishing attacks.

Thieves have come to exploit this, by applying social engineering techniques to portray an urgency and familiarity in eliciting sensitive personal data. And through the advent of autofill—a standard feature of many web-browsers—this is even more dangerous, as it may be readily passed from network connected devices onto unintended recipients.

Some examples of social engineering include receiving a warning message from a bank, which appears to be notifying of the bank declining a suspected fraudulent transaction (which never occurred). This is already a common occurrence for some cardholders, given the volume of payment card transactions still using entirely fixed numbers (such as CNP online payment numbers, which are sometimes stolen and fraudulently re-used), therefore banks and issuers have come to profile card usage, and will pre-emptively decline usage that they determine to be outside of (their profile-of) regular cardholder spending patterns.

In a more recent wave of attacks, a text message purports to be from a package delivery service about a package to pick up, once the claimed error in postage is corrected. The text message includes a link which is designed to present a familiar logo, fraudulent package tracking information, and demand payment information in order to release the package.

These attacks tend to convey both: a sense of urgency, and familiarity—and designed to elicit a “knee-jerk response” to disclose sensitive information of the victim. For example, a bank payment-declined alert steers the victim to a very similar looking website to enter/autofill their credit card details.

The style of these attack is particularly challenging to address through other methods, such as education, since the attacks continue evolve rapidly, becoming more sophisticated and widespread through automated phone/text/email messaging services. Further, these attacks have come to be directed at devices we have traditionally trusted (such as directed message, seemingly from our bank, mentioning our account number, sent directly to a personal email/phone that matches said account). Meanwhile, an increasing percentage of the population who came from before the era of online communications, personal computing devices, worldwide networks and online shopping, can prove difficult to educate. For example, everything may appears both important and trustworthy, untrustworthy and inactionable. Either attitude can prove susceptible to social engineering attacks.

Another type of attack can involve the ubiquity and trust of quick response (QR) codes. QR codes are two-dimensional bar codes that can cause phones or computing devices to automatically open a web browser or application upon a successful scan. Malicious parties can configure QR codes to lead to look-alike websites that are configured to receive payment information. Such malicious parties can place the QR codes in locations where individuals may expect to make a payment to trick the individuals into providing their payment information to the malicious parties. In one example, a malicious party may place a malicious QR code over a valid QR code at a payment kiosk for a parking facility. The malicious QR code can be configured to take individuals attempting to pay for parking to a website look-alike of the payment website for parking at the parking facility. Because individuals may not suspect or be on alert for fraudulent activity when making a payment for parking, an individual may not pay attention to the URI or other aspects of the website to determine whether it is a fraudulent site. Accordingly, the individual may input his or her payment information into the fraudulent site for payment, funneling the payment and/or payment information to the malicious party rather than the entity that operates the parking facility.

One commonality in many attacks is that a URI (e.g., Web-site: URL, SMS/Text sender number: URN), are recognizably fake—and with the right set of flexible analysis tools, this could be detected a-priori, and reported, before mistakes occur.

A removal of the use of fixed payment information (e.g. from standard auto-fills of static information), and introduction of limitations-of-use into the sensitive information stored and generated at the device itself can prove useful. Dynamically generated information can be auto-filled, providing a user with autofill of SmartTokenized payment information at a time of checkout, through a web-applet extension available in the browser. Wherever electronic devices can be exploited by hackers to assist fraud (such as in a phishing attack to garner sensitive personal, or financial details), the payment information can be generated securely within the device itself, be limited to a specific device and user, type of payment facility, and use secrets to support issuer revocation. SmartTokenization can include methods and apparatuses for the generation of financial payment card numbers (partly on-the-fly) at the device, which are compatible with the existing card payment transaction formats, and suitable for use in securing online and in-store payments, with built-in limitations which can help prevent use or a misuse (e.g., beyond a user's intentions) including auto-filled payment information generated for a specific merchant ID and not usable in a fraudulent merchant misrepresentation, or auto-filled payment information that dynamically alters with each sequentially counted transactional-use which will not work again if copied and a reuse is attempted.

Further provided according to the present disclosure are improvements to a device's selections at the time of data entry (e.g., before the personal or financial details are generated) and the assistance with automating the (phished) data entry. For example, the electronic device can detect such online scams (such as fake websites), and provide a) a risk score or confidence level to the user; or b) into the choice of limitations-of-use in the generation process; into the RPA process itself; or c) to decline to perform the auto-fill (or other RPA) at all. Such an approach may, thereby, prevent the device (and its operating software) from complicitly aiding scams by expediting compliance with phishing attacks (or at least aiding a user to avoid the attack).

To understand how connected devices can detect such risks, it may be useful to understand how the network connected devices see connections (to internet server, web hosts, domains, emails, text message senders, etc.), and how messages from this location/name/identifier can be analyzed to provide risk analysis. This analysis can be applied to, for example, safer RPA (such as auto-fill of sensitive credit card info) data entry.

For the purposes of brevity, hosts, domains, web-site links, SMS text numbers, email recipients, and the like may be referred to according to the standard terminology of Uniform Resource Identifier (URI). The URI typically represents two main categories of resource descriptors: URLs (Uniform Resource Locators) and URNs (Uniform Resource Names). One simple way to differentiate is that while a URL typically identifies the location of a resource on the internet by its internet address, a URI can identify anything anywhere, not just on the internet.

The URI is typically a sequence of characters that identify a name or a unique resource. In this disclosure the term will comprise the superset of both URL's and URN's, combinations thereof, an interactive application, information, or another resource. A URI can contain a scheme, authority, path, query, and fragment. Some common URI schemes are HTTP (Hypertext transfer protocol), HTTPS (e.g. HTTP using SSL or transport security protocols (TLS) secure sockets), FTP or FTPS (the secure sockets version), Idap, telnet, eMail, etc. Some examples of URI's can include: mailto:info@example.com (specifying an address to be used via email), urn:isbn:978-3-16-148410-0 (identifying a book), tel:+1-212 -555-1212 (a telephone number).

A URL (Uniform Resource Locator) is a specific type of URI that is often defined as a string of characters that is directed to an internet domain (e.g. cardware.com) or an address. They are commonly used together with a name to locate specific resources on the web (e.g. https:// can be combined with cardware.com). The URL also provides a way to retrieve the presentation of the physical location by describing its network location or another primary access mechanism.

A URN (Uniform Resource Name), is a type of URI that identifies a resource by name, rather than location. URNs can provide a persistent and location-independent way to identify resources. For example, a URN can be used to identify a specific book in a library catalog, regardless of where the book is physically located.

In some operating systems such as iOS, Android, and MacOS, the URL is not necessarily contained in an embedded link, or downloaded. html file. A QR code or an NFC tag can convey a URI such as a URL. For the sake of clarity, this disclosure covers analysis of and action from URI's, in all forms of encoding, whether expressed in plain text, a hyperlink, image code, wireless tag, or any other embodiment.

Furthermore, even where a URI is provided in the form of a URL, the URI can refer to resources other than a webpage to be browsed. The URI can cause the operating system to download or launch an application. For example, on entering an Apple Store to make a purchase, a merchant may present a QR-code on a Point-of-Sale (PoS) device, in order to complete a checkout. This QR-code can contain a URL that is associated with the “Apple Store” app contained in the device's app Store for download. Once downloaded this App can further assist in the checkout process, for example, by entering the Apple ID associated with the end-customer warranty.

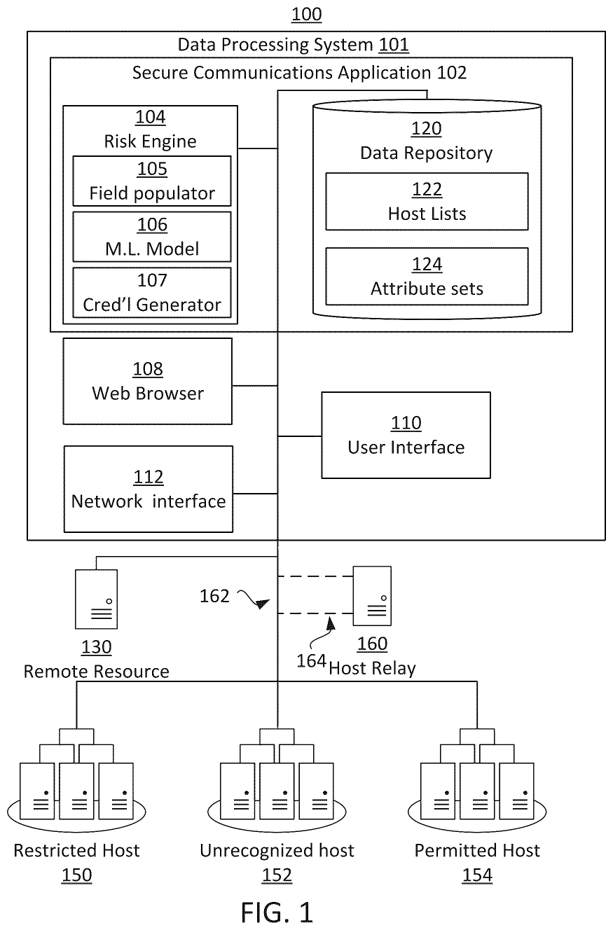

FIG. 1 is a block diagram for an environment 100 including a data processing system 101 configured for secure communications, according to some embodiments of the present disclosure. The data processing system 101 can include or be instantiated by a computing device, such as a mobile phone, desktop or laptop computer, or another device, or combination of devices, including one or more processors coupled with memory.

The data processing system 101 can communicatively couple with at least one host device, such as a host for at least one resource of a website, text message, email, mobile application, or so forth. In some embodiments, the host devices can correspond to legitimate or spoofed instances of a web page and implement a form handler configured to receive data from one or more entry fields. For example, the entry fields of a web page may be presented by a general-purpose web browser or an application (e.g., a mobile application), whereby the form handler is implemented to receive information therefrom. The hosts can include restricted hosts 150 (sometimes referred to as untrusted hosts, without limiting effect), which may correspond to a denial list of host lists 122 of the data processing system 101. The hosts can include permitted hosts 154 (sometimes referred to as trusted hosts, without limiting effect), which may correspond to an allowance list of the host lists 122. The hosts can include unrecognized hosts 152, which may be absent from the host lists 122 (e.g., absent from both the denial list and the allowance list of the host lists 122). Further, in some cases, a host relay 160 can relay communication between the data processing system 101 and another host (e.g., a permitted host 154) as may be used to exfiltrate data communicated between the data processing system 101 and the other host.

In some embodiments, any of various aspects of the present disclosure may be executed by the data processing system 101 (e.g., executed locally at a mobile phone or laptop computer). In some embodiments, the data processing system 101 can communicatively couple with a remote resource 130 configured to perform certain operations, which may reduce a compute demand at the local device, aggregate data from multiple instances of the secure communications application 102 (e.g., multiple mobile phones or laptops, which may be used to append or modify host lists 122, or update one or more machine learning models 106). However, the availability of the remote resource 130 may be intermittent, such as according to the status of the remote resource 130 itself, an availability of a connection thereto, or a data sharing selection of a user, firewall, etc. Accordingly, in some embodiments, the data processing system 101 is configured to operate in a local mode.

In some cases, a host relay 160 can relay network traffic between the data processing system 101 and various of the hosts. In some circumstances, the host relay 160 can correspond to a proxy or virtual private network (VPN) employed by a user. However, in other cases, the host relay 160 may be operated by a malicious operator. For example, the host relay 160 can establish a first connection 162 with the data processing system 101, and a second connection 164 with a host, such as a permitted host 154. The host relay 160 can thereafter capture information transmitted from the data processing system 101 via the first connection 162, such as entry field content, cookie data, or so forth.

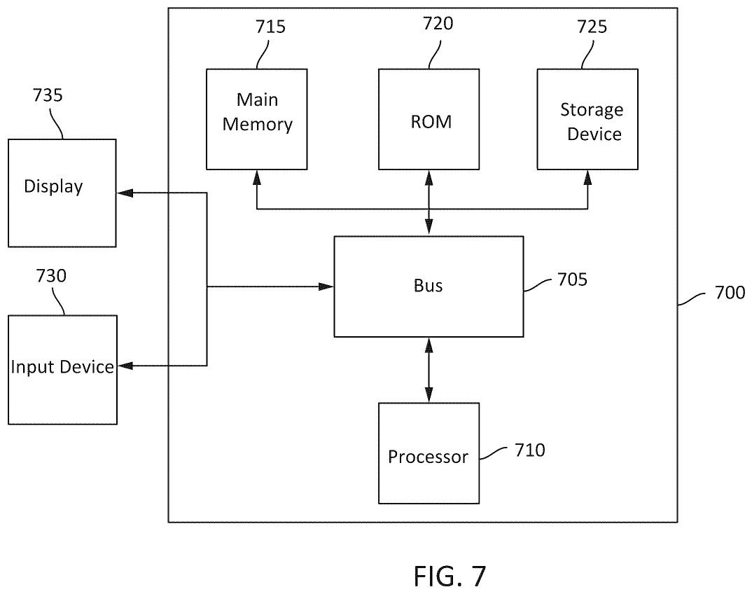

The risk engine 104, web browser 108, user interface 110, or network interface 112 can each include at least one processing unit or other logic device such as a programmable logic array engine, or module configured to communicate with the data repository 120 or database. The risk engine 104, web browser 108, user interface 110, or network interface 112 can be separate components, a single component, or part of a device, such as a mobile phone, laptop computer, desktop computer, or so forth. The data processing system 101 can include hardware elements, such as one or more processors, logic devices, or circuits. For example, the data processing system 101 can include one or more components or structures of functionality of computing devices depicted in FIG. 7.

The data repository 120 can include one or more local or distributed databases, and can include a database management system. The data repository 120 can include computer data storage or memory and can store one or more data structures, such as host lists 122 or attribute sets 124.

A host list 122 can refer to or include a predefined set of hosts. A predefined set of hosts can correspond to a set of trusted hosts, wherein the host list 122 can be referred to as an approve list. In some embodiments, the host lists 122 can include a list of known malicious hosts (e.g., a deny list). In some embodiments, the host lists 122 can include a list of hosts associated with any of the attribute set 124 data (e.g., all URLs merchants accepting a particular payment card network). In some embodiments, a merchant can be (or be associated with) an issuer. For example, a retailer can issue (or partner with a financial institution to issue) a payment card. Accordingly, the host list 122 can include an association between the host and the payment card.

In some cases, the host list 122 can refer to or include a URL or other URI of a merchant, such as a URL of a web site. In some cases, the host list 122 can include further data associated with a host, such as a provider of a security certificate, a port number, an IP address, or so forth.

In some embodiments, the host lists 122 can include a list of host-sites, host-sub-domains, host-sub-folders and host-payment-pages associated with an incentive. For example, the incentive may be particular to a merchant corresponding to one or more hosts (e.g., three retailers and their corresponding URL's), or a merchant type (e.g., all home improvement stores). The incentives (e.g., rebates, points, miles, discounts, or so forth) can include an inventive value, such that the data processing system 101 can rank-sort available incentives according to a value thereof. In some embodiments, incentive data may be stored on a per-credential basis, such that the incentive data may be referred to as an attribute of an attribute set 124. Indeed, variations of the data repository 120 may be stored according to any of various data structures (e.g., a single data structure, separate data structures organized by user, credential, host, host type, host sub-domain, host payment pages, and such).

The attribute set 124 can refer to or include attributes associated with a user, which may be stored for automatic population into entry fields, or manually entered by a user, via a user interface 110. For example, such attributes can include a name, email address, physical or billing address, password, PIN, credit card or other account number or other data (e.g., expiration date, billing address, card verification code or value (CVV/CVC)), crypto-wallet key, or other data. In some cases, the attribute set 124 can include dynamically generated portions for entry into a particular field. For example, the attribute set 124 can include an attribute of a limited use payment information, through which payment transactions may be limited to: a one-time use or a limited number of recurrent-usages, a time, a period of duration, an amount, a credit limit, a specific merchant or merchant-of-record, a location or geography, a specific facility or payment reader or payment system, or include other restrictions to avoid exploitation by a restricted host 150. For example, in some embodiments, the attribute can include a fixed portion, and a dynamic portion for a specific transaction amount authorized for receipt by a particular merchant or merchant type, or a geofence, or limited duration time window, which may be generated by the risk engine 104.

A secure communications application 102 of the data processing system 101 can include a field populator 105 to automatically populate entry fields presented by web pages, which may be provided by a web browser 108, or another application configured to present web pages, which may include various mobile applications configured to present entry fields operatively coupled with a form handler of a host. In some embodiments, the field populator 105 is configured to interface with an application, such as the web browser 108, to control (e.g., initiate, inhibit, or allow) population of entry fields. For example, the field populator 105 can generate an overlay to mask or otherwise block a manual entry into the entry fields, prompt a user to avoid entry according to a presentation of a risk level indicator, disable an auto-population function for one or more entry fields, or initiate/allow the auto-population as may be performed by the web browser 108.

A secure communications application 102 (e.g., a first application) of the data processing system 101 can identify the host. In some cases, the secure communications application 102 can identify the host based on a uniform resource locator (URL) or other URI (or other unique or non-unique identifier) associated with an entry field (e.g., for a web page including the entry field). A risk engine 104 (e.g., a rules engine) of the secure communication application can identify a host as a restricted host 150 or permitted host 154 based on a comparison to a predefined host of a host lists 122. In some embodiments, the risk engine 104 can classify an unrecognized host as a restricted host 150 or permitted host 154 based on an execution of one or more machine learning models 106, which may be trained based on tagged instances of spoofed or authentic web pages, or based on various data as may be retrieved from various remote resources 130 such as WHOIS data, DNS data, secure socket layer (SSL) data, etc. Further, the risk engine 104 can identify a host as a restricted host 150 based on any of the techniques described herein to classify an unrecognized host 152. For example, the risk engine 104 can determine that a host matching a permitted host 154 according to a host list 122 is a restricted host based on a self-signed SSL or other certificate, use of a non-secure protocol, or information received from a remote resource 130 as may indicate a compromised site.

In some embodiments, the risk engine 104 can classify an otherwise permitted host 154 as restricted incident to a detection of a host relay 160. For example, the risk engine 104 can cause network traffic to be transmitted to a remote resource 130, via the network interface 112 (e.g., a wireless interface). The risk engine 104 can thereafter receive, via the network interface, an indication of a source of the network traffic from the remote resource 130 (e.g., tuple information or time delay) and determine if the indication of a source matches the data processing system 101 or differs therefrom. That is, the secure communications application 102 can establish a secure connection with a first host, the first host disposed remote from a device of the data processing system 101 (e.g., remote from a non-transitory computer-readable medium thereof); the secure communications application 102 can generate network traffic to a second host, the second host configured to identify a source of the network traffic. The secure communications application 102 can determine a presence or an absence of an intermediary disposed between the user device and the second host based on tuple information of the network traffic. For example, where an IP address of the host relay is distinct from an expected IP range, the secure communications application 102 can determine the presence of the host relay 160. Upon non-detection, the secure communications application 102 can transmit, to the first host, data based on stored user credentials and the absence of the intermediary.

As indicated above, in some embodiments, the risk engine 104, or other components of the secure communications application 102 can be implemented via one or more remote resources 130. Such implementations can be provided in addition to or instead of a local instance of the data processing system 101. For example, in some embodiments, a first machine learning model 106 is implemented locally for use during a local mode, while a second machine learning model may be implemented at one or more remote resources 130 for an online mode. The remote resource 130 and data processing system 101 can share model data. For example, the remote resource 130 can provide an update to a local model, or the secure communications application 102 can convey data to the remote resource 130 as may be used to train/update a machine learning model thereof.

Referring specifically to the machine learning model 106, a deep learning model trained on textual data of further URI can be used to capture the semantic meaning of various components of a URI. This model can process text inputs by breaking them down into symbolic-tokens and then transforming these symbolic-tokens into continuous vector representations, or embeddings, that reflect their contextual meaning. Accordingly, the machine learning model 106 can generate embeddings that place semantically similar text closer together in vector space, even if they use different wording. For example,. com and. org top level domains (TLD) may be close in a vector space corresponding to trust or phishing, due to high levels of trust, wherein. cm and. com, although textually similar, may be distant in such a vector space. Similarly, a vector space for security can proximally include HTTPS:// and wws://, while HTTPS:// can be distant from HTTP://, despite the visual similarity. In various embodiments, flags may be dedicated to certain of the features (e.g., HTTP: can be flagged as a restricted host 150). However, other of the features can be matched to a predefined host of a host list 122 according to a similarity therebetween (e.g., a cosine or Euclidean distance in a multi-dimensional space). In some embodiments, the machine learning model can generate a match score according to a distance between the received host and the predefined host, such as may correspond to a confidence of a match. Content of the URI can further modulate a confidence. For example, long URLs, or unexpected embeddings (e.g., a zero substituted for an oh in a text stream, such as https://ma1ic0usD0main . . . /. . . ) can lower a match confidence, or lower a confidence that a host should be trusted.

In embodiments of the present disclosure using a transformer machine learning model 106, features are determined through the self-attention mechanism, where each symbolic token in a sequence computes its relationship to all others using queries, keys, and values. This allows the machine learning model 106 to weigh relevant symbolic tokens based on context, producing embeddings that capture both local and long-range dependencies. Each layer refines these embeddings, leading to a contextual representation of the input. For searching, the machine learning model 106 can compare these embeddings in a high-dimensional vector space (e.g., the multi-dimensional space referred to above). By using measures of spatial distance to infer similarity, the machine learning model 106 identifies symbolic tokens or sequences with similar meanings, aided by the self-attention mechanism, which dynamically adjusts each symbolic token's relevance based on the full context of the sequence. References to an illustrative example of a textual transformer model, or an ingestion of an URL should not be construed as limiting. According to various embodiments of the present disclosure, various machine learning models 106 can be employed. Further, a transformer or other model can operate with further content data, such as textual or image data, some examples of which are discussed throughout the present disclosure.

The secure communications application 102 can include a credential generator 107 configured to generate a credential, such as a limited use attribute, as described above with regard to the data repository 120 (and provided with further detail according to various of the applications incorporated by reference). The credential generator 107 can operate according to the various aspects of such disclosures.

A web browser 108 (e.g., a second application) can refer to an application defined according to a set of instructions which, when executed by one or more processors of the data processing system 101, causes the processors to generate a display of content. For example, the content can be provided a network such as the internet, a private network, or another local network (including content provided via a localhost). The web browser 108 can generate entry fields corresponding to a form handler or other resource of a host (e.g., a restricted host 150 or permitted host 154). In some embodiments, the web browser 108 may be implemented as a general-purpose web browser, configured to navigate to a URL entered via an address bar and present objects received from various hosts (e.g., images, textual content, the entry fields, etc.). Some of the presented objects can include or correspond to various URI, such as URL links. In some embodiments, the web browser 108 can be implemented as a mobile or other application which is also configured to present content to a user based on a connection with a host via a URL or other URI. In some cases, the web browser 108 can be another type of application configured to present a user interface including web forms that can be auto-populated or restricted from being auto-populated or populated using through the secure communications application 102.

The terminology “web browser 108” as used herein, can include mobile applications including entry fields configured to convey content of entry fields to a remote host, as in the case of an application of a drop shipper or other third-party reseller, or a social media property. Accordingly, the terminology of a “web page” can refer to either of a web page which is navigable using a general-purpose web browser, or another application, such as the illustrative examples of the mobile applications described above.

A user interface 110 is the point of interaction between a user and an application, such as the web browser 108 provided above or a display of a device. The user interface 110 is designed to facilitate the exchange of information from a host to a user. For example, the web browser 108 can cause the user interface 110 to display text, graphics, entry fields, radio buttons, or other selectable and un-selectable content. Further, the user interface 110 is designed to facilitate the exchange of information from a user to a host. For example, the user interface 110 can be configured to receive information from a user or a device thereof. The user interface 110 can receive data manually entered by a user, as in the case of data entered via a keyboard or touch screen (e.g., the touch screen display 735 of FIG. 7). The user interface 110 can receive data previously entered or otherwise provided to the web browser 108, for field population via an auto-population feature of the web browser 108 or other application. Some examples of such data can include, for example, a name, address, credit card information, two factor authentication value (2FA), or other content may be accessible to the secure communications application 102, from a data structure (e.g., the attribute set 124) or from another application.

A network interface 112 is a communications link between one or more devices of the data processing system 101 and network-connected devices, such as a remote resource, host, or host relay. For example, the network interface 112 can include wired or wireless interfaces, and can include be configured for communication over any of various protocols, such as cellular networks, Ethernet, Wi-Fi, Near-Field Communications, and so forth. The network interface 112 can include components at various levels of a stack (e.g., levels of the open systems interconnection, OSI model). For example, the network interface 112 can include physical layer or application layer components, according to various embodiments. For example, as used herein, a wireless or other network interface can refer to any of a transceiver, a media independent interface, or various buffers or data structures as may be implemented at various layers of the communications stack. In some embodiments, the network interface 112 may be configured to provide information related to an address of a remote host. For example, such information may be provided as tuple information for a packet, or other identifiers for electronic communication.

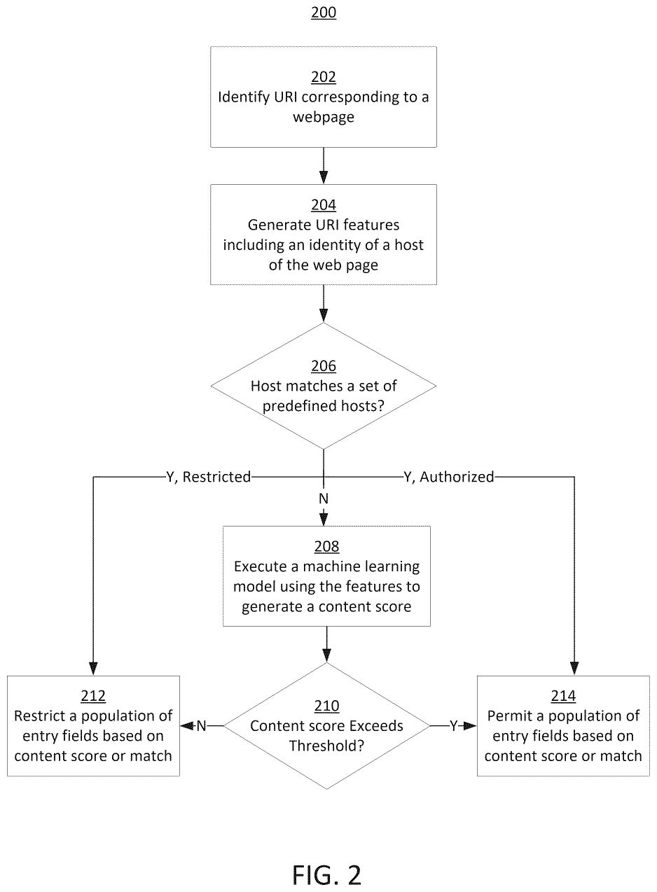

FIG. 2 is a flow diagram for a method 200 of secure communication, according to some embodiments of the present disclosure. The method 200 can be performed by one or more systems or components depicted in FIG. 1 or FIG. 7 including, a data processing system 101, a remote resource 130, or a computing device associated therewith. For example, the method 200 can be performed by one or more processors of a mobile phone, laptop, desktop, or other computing device and a memory communicatively coupled therewith. Merely for clarity of the description, the present method 200 will sometimes be described as performed by secure communications application 102 of a mobile device such as a mobile phone, tablet, or laptop computer. The secure communications application 102 is communicatively coupled with an illustrative example of a remote resource 130 of a single server configured to communicate with further resources. Such a description should not be construed as limiting. For example, in some embodiments, the method 200 may be performed locally (e.g., with a localhost), via connecting to multiple remote resources 130, or without communication to further data sources (e.g., the remote resources 130 can aggregate or cache certain information).

The operations provided herein, or the sequence thereof should not be construed so as to limit the present disclosure. Various operations may be omitted, added, substituted, or modified, according to various aspects of the current disclosure, inclusive of the references incorporated herein. Moreover, operations can be performed in various sequences according to various implementations.

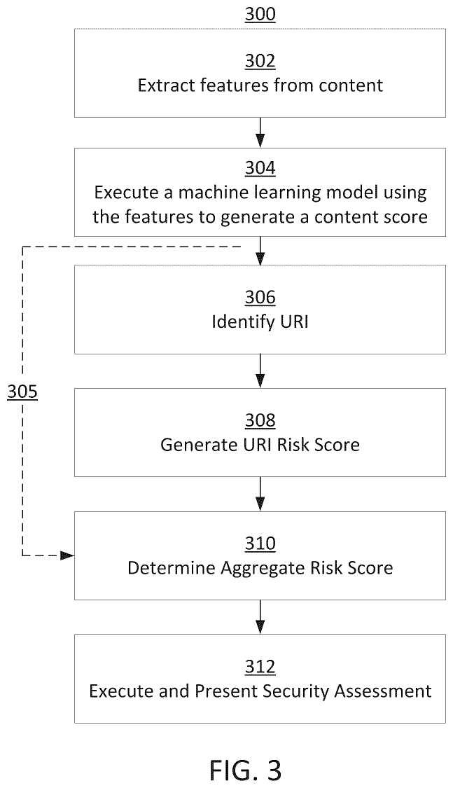

At operation 202, the secure communications application 102 identifies a URI corresponding to a web page. For example, a user of a mobile device can open a web browser 108 in communication with the secure communications application 102, such that the secure communications application 102 receives a URL as presented in an address bar. In some embodiments, the secure communications application 102 can otherwise receive a URI. For example, in some embodiments, the secure communications application 102 is operatively coupled with a text message program or email program, and can receive an indication of a URI therefrom, some examples of which are described henceforth with regard to, for example, the method 300 of FIG. 3.

At operation 204, the secure communications application 102 generates URI features including an identity of a host of the webpage. The URI features can correspond to, for example, a remote pattern generated by the secure communications application 102 using the URI. For example, the secure communications application 102 can parse a URL to determine a communications scheme (e.g., hypertext transfer protocol, HTTP, or secure HTTP, HTTPS). The remote pattern can include parsing a URL to determine a domain, port, path, fragment, or other portion of the URL. In some cases, the host may be identified according to a top level domain (e.g., .com, .biz, .tk, .cn, ru, or .xyz,), second level domain, or another subdomain.

At decision block 206, the secure communications application 102 determines whether the host matches a predefined set of hosts. To match the host to a predefined host, the secure communications application 102 can match all or a portion of a URI to a predefined host. In some cases, such a determination can include a comparison of a distance between of the host and the predefined host in a hyperspace to a threshold, although such embedding and search need not be relied upon in all embodiments. For example, a predefined host can be associated with a website according to an exact match or a match of portions of a domain (e.g., the TLD, SLD, or communications scheme). In some embodiments, the match can include or be contingent upon receipt of information accessed via a remote resource 130, such as may indicate a hijacking of a web site, such as an updated registration, lack of an email server, or registration through a high-risk registrar or in a high-risk country.

Responsive to an indication that the host matches a predefined host of an allow list, the method 200 can proceed to operation 214. Responsive to an indication that the host matches a predefined hosts of a restrict/deny list, the method 200 can proceed to operation 212. Responsive to an indication that the host does not match a set of predefined hosts, the method 200 can proceed to operation 208, to classify the unrecognized host 152. This list of predefined or known hosts can be augmented dynamically (e.g., by a user manually enabling a host as trustworthy, or through an application provider's affiliation program to elevate a specific host(s) or location(s), as trustworthy as in the case of reputationally augmenting and adding-to a known host list).

As is depicted, the determination of decision block 206 can include comparisons to various predefined sets of predefined hosts, which may correspond to multiple host lists 122. For example, the depicted embodiment illustrates a determination of a match to an “authorized” host list 122 and a “restricted” host list 122. In some embodiments, the secure communications application 102 can determine further match types. For example, a “restricted” host list 122 can include various restrictions (or various constituent lists). For example, a first restricted list may include websites which are known phishing vectors and without legitimate function. A second restricted list may include websites including a combination of legitimate and fraudster merchants (e.g., third party marketplaces). A third restricted list can include trusted merchants, but exhibit a high incidence of charge backs for a subscription renewals.

Further, at decision block 206, the secure communications application 102 can match a host to an affiliated merchant. An affiliated merchant may refer to or include a merchant offering an incentive as indicated in the data repository 120 (e.g., the attribute sets 124). The secure communications application 102 can take further action responsive to a detection of an affiliated merchant. For example, a credential generator 107 can rank various credentials of the attribute sets 124 according to an incentive. For example, if a first payment card is offering a one percent rebate and a second payment card is offering a two percent rebate for a particular host, the communications application 102 can rank the payment card offering the two percent rebate first (e.g., highest), the payment card offering the one percent rebate second, and another payment card (e.g., a default option) third. In some embodiments, the credential generator 107 is operatively coupled with the user interface 110 to cause a display of a selection of the incentive based on an attribute set 124 (e.g., payment cards present in a virtual wallet). In some embodiments, the credential generator 107 is operatively coupled with the user interface 110 to cause a display of a credential absent from a virtual wallet (e.g., indicating that a five percent incentive is available for a card not stored in a virtual wallet application).

At operation 208, the secure communication application 102 executes a machine learning model to generate a content score. In some instances, to generate the content score, the secure communications application 102 can interface with a remote resource 130. For example, the secure communications application 102 can determine, based on an availability of the remote resource 130, user setting, configuration operation, or other criteria, whether to proceed in an on-line mode or an off-line mode. In either of an off-line or an on-line mode, the secure communications application 102 may use certain features extracted from the URI at operation 204. For example, even where a communications scheme, top level or other domain, or path is not matched to a predefined host, the communications application 102 can generate a URL score based thereupon. For example, a non-secure HTTP protocol, .ru TLD, length of a URI, or other features can indicate elevated risk. Further, in some embodiments, the secure communications application 102 can extract features from the web page including the entry fields and further generate a content score. Indeed, the communications application 102 can execute any of the operations described as performed at a server of a remote resource 130.

When proceeding in an online mode, the secure communications application 102 can interface with the remote resource 130 to determine the host type (e.g., restricted or permitted). The remote resource 130 can couple with a data provider for SSL information (e.g., a certificate signatory, date, expiration, type, etc.). The remote resource can couple with a data provider for DNS information (e.g., IP range, name server or canonical name (NS/CNAME) records, start of authority records, unusually low TTL values, or so forth. The remote resource can couple with a data provider for WHOIS data, such as a domain registration data, associated email server, registrant information (e.g., location or identity), registrar information (e.g., location or identity), expirations dates or update histories.

In some embodiments, the remote resource 130 can further generate a content score based on various content of the web page. The content can include images, text, other content. For example, one or more instances of the machine learning model 106 may be trained using first tagged web pages for spoofed sites and second tagged web pages for authentic sites.

In some embodiments, the content score can further include data from other operations of the machine learning model 106, or other flags or discrete determinations determined by the secure communications application 102 (e.g., the model can ingest the flags). In some embodiments, the content score can be generated separately from other scores, such as a separate URI score, WHOIS or other domain registration scores, SSL certificate, a 3rd party signed X.509 certificate, or other security scores, DNS or other domain name scores, wherein the scores may be aggregated according to a simple summation, weighted average (e.g., dynamically weighted average), or other technique. For example, a web site including a non-self-signed certificate may be provided relatively little weight towards trust (e.g., can contract a hyperplane distance or adjust a score positively only slightly), whereas, conversely, the presence of a self-signed certificate may be weighted heavily to expand a hyperplane distance or adjust a score negatively.

An example of a content score for visual content can include ingesting the visual content, by the machine learning model 106, as an image or detecting a textual content (e.g., using optical character recognition, OCR, or various natural language processing, NLP techniques). The textual content can thereafter be ingested by a transformer or other machine learning model 106 to detect a content score. For example, where the image includes text that is common in legitimate sites as textual content rather than image content, a content score associated with a host for the website or other content may be modulated to indicate low trust, relative to other hosts.

At operation 210, the secure communications application 102 compares one or more scores, flags, or other indicia of a host of content to one or more thresholds. In some embodiments, the various thresholds can include thresholds for a risk type. For example, a first risk type may be associated with phishing, a second risk type may be associated with malware, and a third risk type may be associated with negative option billing (e.g., subscription traps).

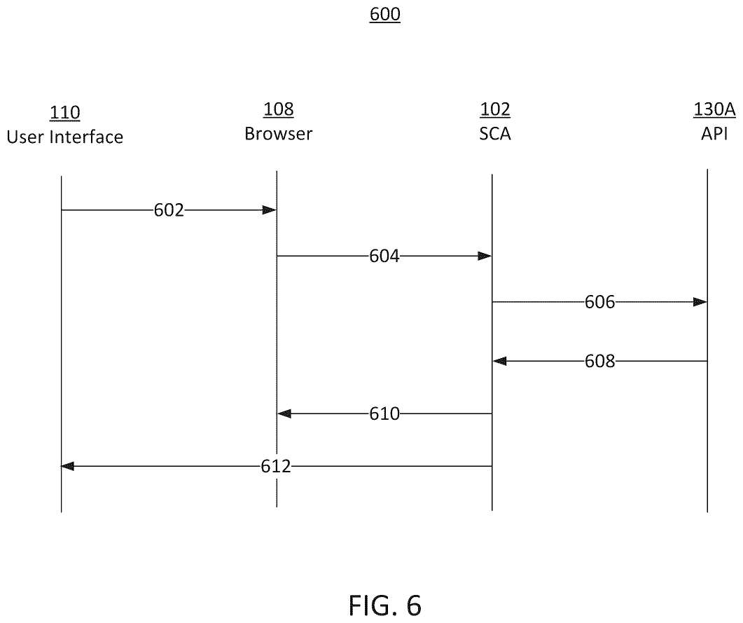

In some embodiments, the various thresholds can include gradations of risk within or between risk types. For example, where the content score is negatively corelated with risk, so that a score of nine indicates high risk and a score of ninety indicates low risk, thresholds may be provided at scores of thirty, fifty, and seventy-five. A remote resource 130 (e.g., applications programming interface, API 130A) can modulate operation based on the comparison to the one or thresholds. Some examples of API 130A operation are provided throughout the present discuss, such as with regard to FIG. 6.

At operation 212, the secure communications application 102 restricts a population of an entry field based on at least one of the match determined at decision block 206, or the content score determined at operation 208. In some embodiments, the secure communications application 102 can prevent display of one or more entry fields. For example, the secure communication application 102 can generate an overlay for a web browser 108 or display a warning to prevent entry (e.g., a warning dialog rendered in a user interface, as may also be referred to as a recommendation, without limiting effect). When integral to a web browser 108, the secure communication application 102 can fail to display the entry fields. In some embodiments, the secure communications application 102 can restrict an auto-population function, such as by blocking the automatic completion of entry fields. As indicated above, the secure communications application 102 may be implemented as integral to a web browser 108, as a plug in for a web browser, or otherwise to interface with the web browser 108 (e.g., as a microservice therefor).

In some embodiments, a restriction implemented by the secure communications application 102 can include a generation of a credential type. For example, a credential generator 107 of the secure communications application 102 can generate a one-time use credential, a limited transaction amount or merchant credential, or other of the limited use credentials discussed herein, inclusive of the incorporated references. That is, the restriction can be implemented on a disabling the entry of non-tokenized credentials. In some embodiments, (or in response to comparisons to some thresholds) such a restriction may be implemented along with a presentation of a control element to allow a user to override the restriction. In some embodiments, (or in response to comparisons to some thresholds) such restrictions may be enforced without presentation of a control element to override the restriction. In some embodiments, the tokenized credentials may have limitations-of-use embedded into the credentials, this aiding the safe use of such tokenized information where it would otherwise have been restricted if it were non-tokenized. Examples of this include where a sequential counter count is embedded into a dynamic portion of said tokenized information such that unless the recipient had the correct sequence count they could not confirm, reproduce, nor re-use the information beyond its one-time intended limitation. Thus aforementioned restrictions may be removed, when a different type of data generation methods are applied. In some embodiments, different methods of data generation may be applicable to encode different limitations and address other inferred restrictions.

At operation 214, the secure communications application 102 permits a population of an entry field based on at least one of a match determined at decision block 206, or a content score determined at operation 208. For example, the secure communications application 102 can cause an auto-population function of a web browser to be enabled, or bypass instructions to disable auto-population function.

In some embodiments, the restriction or permission can include generation of a combined data structure. For example, the data processing system 101 can determine an appropriate method of a generation for a dynamically generated data element (e.g., payment number or sensitive data elements) for entry fields of the webpage. The data processing system 101 can combine such dynamic data elements with other status elements into a combined data structure capable of auto-population. The combined data structure can map to one or more entry fields. For example, in some embodiments, the combined data structure can relate to a single data field (e.g., concatenating the static and dynamic data elements into one entry field). In some embodiments, the combined data structure can relate to multiple entry fields (e.g., some entry fields corresponding to static elements such as names or zip codes and some entry fields corresponding to dynamic data elements for payment information). The data processing system 101 can populate fields of forms from the combined data structure.

The data processing system 101 can determine the appropriate method of generation of the dynamically generated data element based on the risk score (e.g., based on a determination of a high (e.g., a range of 66-100), medium (e.g., a range of 34-65), or low risk (e.g., a range of 1-33) score). For example, the data processing system 101 can implement a method to generate a one-time user, card-on file, amount restricted, or other dynamically generated data elements according to the risk score. For instance, the data processing system 101 may determine which elements can be included in the generated data element based on which risk score bracket the risk score is in (e.g., the data processing system 101 may only include a social security number in a generated data element for low risk scores but may include phone numbers in generated data elements for high risk scores).

In some embodiments, the data processing system 101 can determine the appropriate method of generation of the dynamically generated data element by determining whether the data element is for restricting, modifying, or permitting auto-population. For instance, a high risk score may correspond to restriction. Accordingly, the data processing system 101 may generate the generated data element by generating a flag indicating to restrict auto-population. A medium risk score may correspond to a modification. Accordingly, the data processing system 101 may generate the generated data element that includes modifications or changes to existing populated elements, such as changes to correct typos or changes to text in specific fields or defined. A low risk score may correspond to auto-population. Accordingly, the data processing system 101 may generate the generated data element to include the relevant or necessary data for auto-population.

FIG. 3 is a flow diagram for another method 300 of secure communication, according to some embodiments of the present disclosure. As for the method 200 of FIG. 2, this method 300 can be performed by one or more systems or components depicted in FIG. 1 or FIG. 7 including, a data processing system 101, a remote resource 130, or a computing device associated therewith. Once again, merely for brevity of the disclosure, certain aspects will be provided in the context of a mobile device such as a mobile phone or laptop. As for the method 200 of FIG. 2, such an illustrative example should not be construed as limiting, and may be modified according to the various disclosure provided herein, including the incorporated references.

At operation 302, the secure communications application 102 extracts features from content. In some embodiments, the content includes textual content, such as a text message received via a text message application of a mobile device or an email received via an email application of the mobile device. The secure communications application 102 can interface with the text message, email, or other application to receive the content. For example, the secure communications application 102 can receive the textual or other content via an API of the application or by recording a screen capture and applying an object character recognition (OCR) technique to determine the textual content.

Upon receipt, the secure communications application 102 can execute the machine learning model 106 to extract features therefrom. For example, a transformer model can generate embeddings using symbolic tokens of the text as may be predictive of a type of host associated therewith. For example, a text message or email indicating a presence of a package for pickup, or an indication of a car warranty status may correspond to features which indicate an elevated association with phishing or other risks.

At operation 304, the secure communications application 102 executes a heuristic and/or machine learning model 106 to generate a content score. For example, the content score can depend on an analysis of the features extracted from the textual content. Accordingly, even where the textual content does not include a valid URI, such as where a space or other placeholder is intentionally placed into an otherwise valid URL to avoid detection by certain filters, symbolic tokens of the URI may nonetheless be ingested by the machine learning model. For example, textual content such as “dot biz” or “.ru” may be ingested and may generate a similar content score as “.biz” or “.ru” in some cases. It also follows that in another exemplary embodiment such simple feature comparisons as direct textual comparisons, can also be performed heuristically i.e. by an algorithm executed in software running on the processor.

In some embodiments, as discussed above with regard to, for example, the method 200 of FIG. 2, the secure communications application 102 can operate between an on-line and an offline mode. Path 305 indicates an online mode of operation, wherein, in addition to any operations performed locally, the secure communications application 102 can provide all or a subset of content and metadata associated therewith to a remote resource 130. For example, a secure communications application 102 of a mobile device can convey an email or text message along with sender information, headers, and so forth to a remote resource.

Incident to path 305, the remote resource 130 can execute online checks, such as those described with regard to operation 208. For example, for an email message or text message, the remote resource 130 can conduct online checks of a source email or phone number, respectively. The remote resource 130 can further determine a score for various URI included in the text content, such as a clickable link in an email, or a reconstruction of the intentionally broken URL described above (as may be determined at operation 306, henceforth).

At operation 306, the secure communications application 102 identifies any URI in the textual content. For example, the secure communications application 102 can be configured to identify valid URI according to deterministic contextual rules of a risk engine 104, or probabilistic rules of a machine learning model 106. For example, the secure communications application 102 can ingest the various symbolic tokens to determine a presence of a valid or invalid URI and may, in some circumstances, reconstruct a valid URI from an invalid URI, such as by removing an extraneous space or replacing “dot” with an actual period.

At operation 310, the secure communications application 102 generates an aggregate risk-score. For example, in the off-line mode, the aggregate risk-score may be equal to a URI risk score or may include other flags or scores as may be generated locally. In the on-line mode, the aggregate risk-score may be generated based on a combination of a locally generated risk score and indications received from the remote resource 130, which may be similar to an aggregated score as discussed with regard to operation 208 of the preceding method 200.

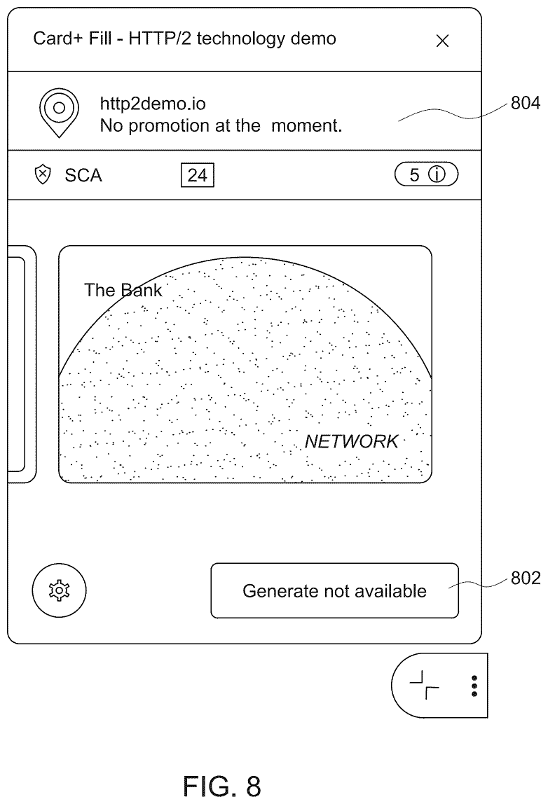

At operation 312, the secure communications application 102 can execute and present a security assessment. Some example security assessments are provided henceforth, according to selected details views of the user interface 110 instances of FIGS. 8-25. Further, in some embodiments, the secure communications application 102 can interface with a web browser 108, text message application, or email application to modulate a display or stability based on the aggregate risk score. For example, the secure communications application 102 can generate a warning, generate an overlay to block a link, cause the link to be non-selectable (e.g., remove a hyperlink from the text), omit the presentation of the link (or the text/email), or replace the link with another resource, such as an anti-fraud alert.

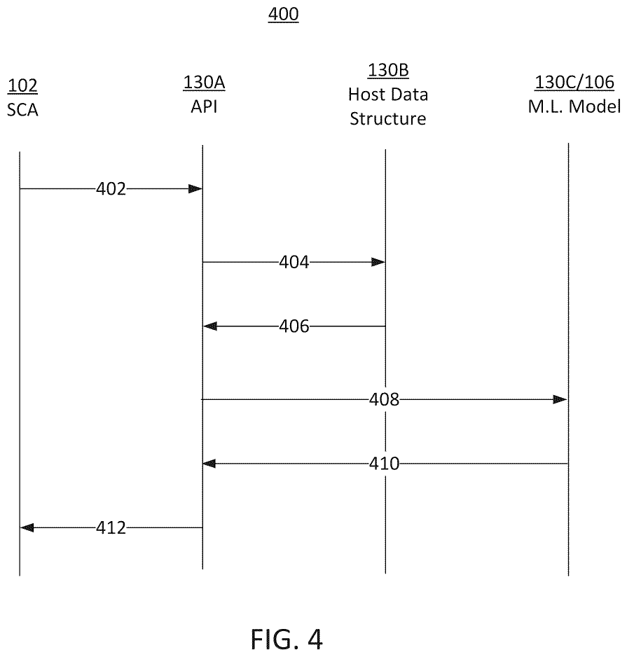

FIG. 4 is a sequence diagram 400 for determining a content score of a web page, according to some embodiments of the present disclosure. The depicted sequence (like those provided hereinafter) is depicted as performed between a secure communications application 102 and various resources as may be implemented at a same data processing system 101 as the secure communications application 102, or may be implemented remote therefrom. More particularly, the secure communications application 102 is depicted as interfacing with an API 130A of a remote resource 130 to establish network communication with a host data structure and a machine learning model 130C. However, such an implementation should not be construed as limiting. According to some implementations of the present sequence diagram, those that follow, or other examples contemplated according to the present disclosure, the secure communications application 102 can interface directly with the host data structure or machine learning model 130C. Such components may be implemented locally on a same device as the secure communications application 102, or the secure communications application 102 can communicate with such components via separate communications channels. For example, the secure communications application 102 may conduct operation 404 locally via a comparison with host lists 122, or conduct operation 408 locally via a local instance of a machine learning model 106 or other aspect of the risk engine 104.

The sequenced events can operate for all URL/URI received at a host, or based on further triggering criteria, such as a presence of an entry field generally, or a presence of an entry field for a particular content type (e.g., payment card information, passwords, etc.).

At operation 402, the secure communications application 102 provides a request to the API 130A. The request can include, for example, the URI itself, or any associated (e.g., served) content or metadata.

At operation 404, responsive to the receipt of the request of operation 402, the API 130A can query a host data structure 130B of a remote resource (e.g., the host lists 122 or a hyperplane database structure including extracted features from tagged instances of various phishing or trusted URI/websites, which may correspond to the host lists 122). For example, the query can cause a command to determine a distance between the received URI and a predefined set of hosts. For example, the query can cause the data structure or processors associated therewith to determine a distance between the received URI and a node or cluster of the hyperplane corresponding to a restricted host 150 or permitted host 154, or can determine an absence of a match. At operation 406, the API 130A receives an indication of a match. Such matches can be provided digitally (e.g., a literal match or non-match of a string) or with a match score. That is, where the determination of the match is not binary, the match may be determined according to a similarity threshold, within the host data structure 130B itself, by the API 130A, or by the secure communications application 102.

At operation 408, the API 130A can query a machine learning model 130C of a remote resource to analyze the URI, domain, or other available information associated with a domain. For example, the API 130A can provide information received from the secure communications application 102, or retrieved based thereupon (e.g., an SSL certificate or WHOIS data retrieved corresponding to a receipt of a URL). In some embodiments, operation 408 is conducted responsive to a non-match of a host at operation 404/406 (e.g., a classification of a host as an unrecognized host). In some embodiments, operation 408 is conducted responsive to the receipt of the request of operation 402. For example, operations 404 and 408 may be conducted in parallel, or in another order without a codependency therebetween. At operation 410, an analysis is returned according to the execution of the machine learning model 130C. For example, the analysis can include a content or other risk score associated with the text/domain/URI received by the API 130A.

At operation 412, the API 130A returns a result from at least one of operations 406 or 410. In some embodiments, the API 130A can generate an aggregate score or otherwise aggregate the results returned at operations 406 or 410. In some embodiments, such an aggregation may be omitted or performed locally upon receipt by the secure communications application 102 Indeed, in some embodiments, any of the operations described as performed by the API 130A may be performed locally by the secure communications application 102.

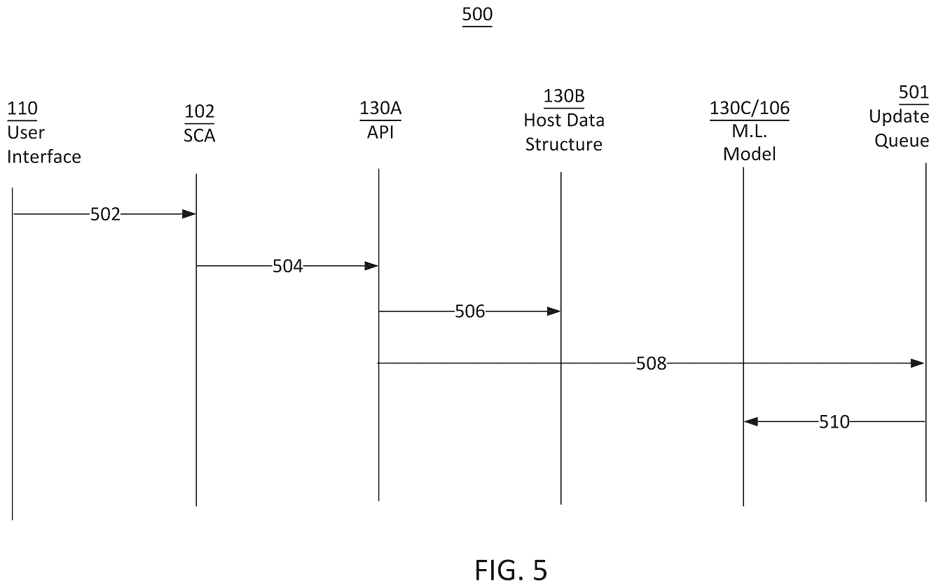

FIG. 5 is a sequence diagram 500 for training a machine learning model 130C, according to some embodiments of the present disclosure. At operation 502, the secure communications application 102 receives an indication of a phishing attempt from a user interface 110. The indication may be generated incident to a manual entry or selection of a user, or according to a further trigger condition as may be performed according to another component of the data processing system 101. Further, in some embodiments, the indication may correspond to a further condition or risk, such as a presence of malware.

At operation 504, the secure communications application 102 generates a report for the indication. For example, the report can include a host URI or other address information (e.g., phone number or email), textual or image content of a web site, time, tuple information, or other data related to the indication. Further at operation 504, the secure communications application 102 transmits the report to an API 130A. As indicated above, such a transmittal may be replaced with local execution of further instructions in some embodiments. However, according to an N:1 relationship between secure communication applications 102 and the API 130A or machine learning model 130C, the transmittal of information from multiple sources can improve the availability of data to train the model, avoid overfitting to a particular user/device, etc.

At operation 506, the API 130A stores the report within a data structure, which may further include a hyperplane, host list, or data related thereto. Such a report may, in some cases, modify or append a host list 122. For example, a report of phishing can cause the addition of previously unrecognized host to a host list 122 of restricted hosts, while a detected false positive can cause the addition of previously unrecognized host to a host list 122 of permitted hosts.

At operation 508, the API 130A provides data for an update to the machine learning model 130C. In some embodiments, operations 506 and 508 can be performed according to separate or same transmissions or other conveyances of data (e.g., local storage). Responsive to the receipt of the data for the update to the machine learning model 130C, an update queuer 501 can enqueue the data until an update. For example, the update queuer 501 can perform updates periodically (e.g., monthly, nightly, etc.), in response to a predefined number of reports, or according to a manual or other trigger condition. At operation 510, the update queuer 501 can, responsive to a triggered condition, cause the machine learning model to be trained based on the data. In some instances, the training can include separate validation operations, such as training the model with a first set of the data and validating the training with a second set of the data, the generation of further synthetic data (e.g., using a generative transformer-based model) to train or validate the model, etc. Subsequent execution of the preceding method can provide improved analysis according to the updated training of the current method.

FIG. 6 is a sequence diagram 600 for presentation of a user interface instance, according to some embodiments of the present disclosure. At operation 602, a user interface 110 receives an indication of a navigational action, such as a user entry of a URL into an address bar of a web browser 108, detecting a click of link to a web page, or an execution of another action URI. At operation 604, the secure communications application 102 detects a page load event, text message, email, entry field presentation, or other trigger criteria, responsive to the receipt of the indication of a navigational action. At operation 606, responsive to the detection of the trigger criteria, the secure communications application 102 sends a request to the API 130A, which may include the URI or other related content.

At operation 608, responsive to a receipt of the request, the API 130A communicates, to the secure communications application 102, a risk score as may be further processed by the secure communications application 102 to determine a further risk score. For example, the secure communications application 102 can aggregate a received risk score with any locally determined scores or flags. At operation 610, the secure communications application 102 can detect a presence of sensitive input elements (e.g., a sensitive-attribute), auto-populatable inputs, or a lack thereof. Response to the detection, the secure communications application 102 can engage certain functionality, such as a control element (e.g., button) to generate or populate credentials, or can, conversely disable such functionality response to a lack of the detection. In some embodiments, at operation 610, the secure communications application 102 can detect types of various fields. For example, the secure communications application 102 can detect a zip code entry field, CVV entry field, payment card number entry field, or so forth, such that a population of such fields may be controlled at operation 612.

At operation 612, the secure communications application 102 can control the population of entry fields. In some embodiments, the control may be responsive to a detection of a gradated risk (e.g., a disreputable restricted host 150 associated with an aggregate risk score less than fifty; a moderately reputable restricted host 150 associated with an aggregate risk score between fifty and seventy or between seventy and ninety; or a permitted host 154 associated with an aggregate risk score greater than ninety). Some examples of controls according to the illustrative example of the gradations of risk are provided henceforth. These illustrative examples should not be construed as limiting. Various functions can be added, omitted, substituted, or modified from a particular gradation or generally, according to the present disclosure. Further, some embodiments, may include additional or fewer graduations, or further types such as malware/phishing which can be associated with different controls.

The secure communications application 102 can control the user interface 110 as described throughout the present disclosure. For example, the secure communications application 102 can interface with a browser to disable certain functionality or prevent display, generate an overlay, or otherwise control the user interface to prevent providing secure data to a malicious host. Further, example user interfaces controlled according to operation 612 and otherwise are provided hereinafter with regard to FIGS. 8-25.

Responsive to a detection of a disreputable restricted host 150 associated with an aggregate risk score less than fifty, the secure communications application 102 can provide an indication of a site as untrusted (e.g., provide a red badge or other notification). The secure communications application 102 can disable a control element to generate credentials (e.g., for a payment card), disable autofill of various fields, such as address data, or block access to such fields (e.g., via a modal overlay).

Responsive to a detection of a moderately reputable restricted host 150 associated with an aggregate risk score between fifty and ninety, the secure communications application 102 can provide an indication of a site as moderately trusted (e.g., provide an amber badge or other notification). The secure communications application 102 can enable an autofill or credential generation function. However, the function may be limited in some embodiments. For example, in some embodiments, a limited use credential may be generated to accommodate a transaction amount indicated via the user interface (e.g., a $100 limit for a $93.27 transaction, or a $93.27 limit for a $93.27 transaction), or according to a merchant type or location, or other information as may be determined via the user interface 110 or web browser 108. In some embodiments, certain functionality may depend on a sublevel of granularity such as a risk type or a gradated risk score. For example, for an aggregate risk score between seventy and ninety, the secure communications application 102 can provide a one-time use credential with an option to provide an unmasked credential, wherein for an aggregate risk score between fifty and seventy, the secure communications application 102 may provide the one-time use credential without the option to provide the unmasked credential. Further examples of limited credentials are provided in the various incorporated references; the secure communications application 102 can generate credentials according to such disclosure. Merely for brevity of the disclosure, such generation is not repeated here in further detail.

Responsive to a detection of a permitted host 154 associated with an aggregate risk score greater than ninety, the secure communications application 102 can provide an indication of a site as trusted (e.g., provide a green badge or other notification). The secure communications application 102 can enable the autofill and generation functions of the moderately reputable restricted host 150. Additionally, where the permitted host 154 is identified as an affiliate host, the user interface may further provide a selection of credentials according to a ranked list of incentives or other associations (e.g., selecting a merchant specific payment card for a merchant, even where an incentive may not be present).

FIG. 7 is a block diagram illustrating an architecture for a computer system that can be employed to implement elements of the systems and methods described and illustrated herein. The computer system or computing device 700 can include or be used to implement a controller or its components, or other components of the environment 100, including the data processing system 101, remote resource 130, or other devices in network communication therewith. The computing system 700 includes at least one bus 705 or other communication component for communicating information and at least one processor 710 or processing circuit coupled to the bus 705 for processing information. The computing system 700 can also include one or more processors 710 or processing circuits coupled to the bus for processing information. The computing system 700 also includes at least one main memory 715, such as a random-access memory (RAM) or other dynamic storage device, coupled to the bus 705 for storing information, and instructions to be executed by the processor 710. The main memory 715 can be used for storing information during execution of instructions by the processor 710. The computing system 700 can further include at least one read only memory (ROM) 720 or other static storage device coupled to the bus 705 for storing static information and instructions for the processor 710. A storage device 725, such as a solid-state device, magnetic disk or optical disk, can be coupled to the bus 705 to persistently store information and instructions (e.g., for the data repository 120).

The computing system 700 can be coupled via the bus 705 to a display 735, such as a liquid crystal display, or active-matrix display. An input device 730, such as a keyboard or mouse can be coupled to the bus 705 for communicating information and commands to the processor 710. The input device 730 can include a touch screen display 735.

The processes, systems and methods described herein can be implemented by the computing system 700 in response to the processor 710 executing an arrangement of instructions contained in main memory 715. Such instructions can be read into main memory 715 from another computer-readable medium, such as the storage device 725. Execution of the arrangement of instructions contained in main memory 715 causes the computing system 700 to perform the illustrative processes described herein. One or more processors in a multi-processing arrangement can also be employed to execute the instructions contained in main memory 715. Hard-wired circuitry can be used in place of or in combination with software instructions together with the systems and methods described herein. Systems and methods described herein are not limited to any specific combination of hardware circuitry and software.

Although an example computing system has been described in FIG. 7, the subject matter including the operations described in this specification can be implemented in other types of digital electronic circuitry, or in computer software, firmware, or hardware, including the structures disclosed in this specification and their structural equivalents, or in combinations of one or more of them.

Referring generally to FIGS. 8-25, some illustrative examples of user interface instances are provided, according to some embodiments of the present disclosure. According to various embodiments, various of the features of the user interface instances may be controlled or presented via a web browser 108 or other application configured to display content, entry fields, or other content associated with a host. In some embodiments, various of the features may be controlled or presented via an application operatively coupled with the web browser 108, such as a browser plugin, microservice, or other applet.

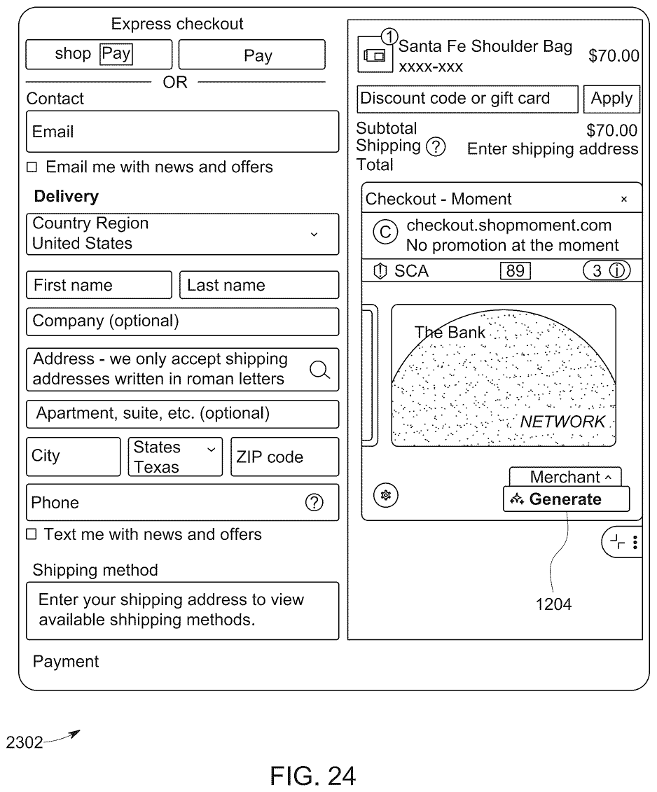

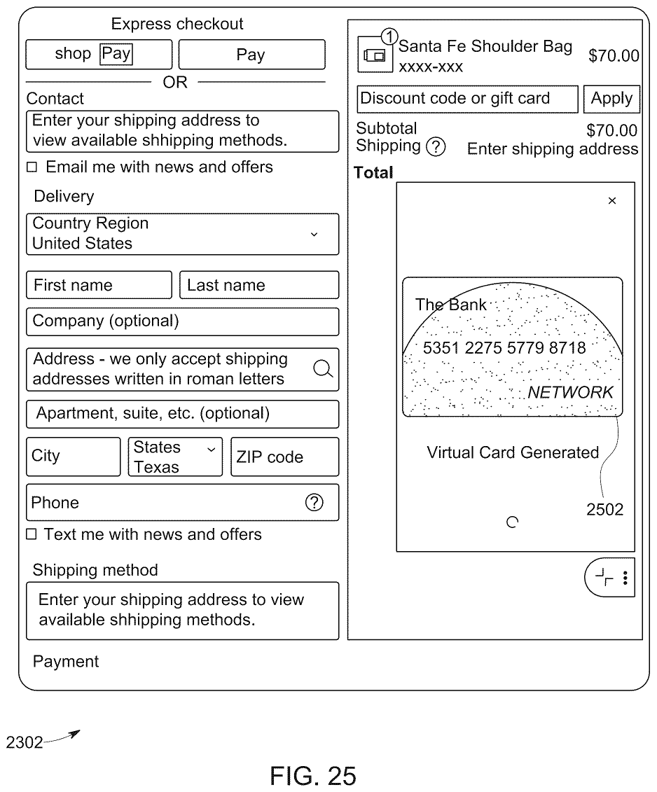

For example, referring now to FIG. 8, an example of a user interface 110 instance (e.g., a mobile application) is depicted indicating an inactive (e.g., greyed out) control element 802 for credential generation. The control element 802 may be inactivated responsive to a determination of a risk score associated with a host for content of a website (not depicted). For example, the inactivation can be responsive to a score of twenty-four out of one hundred. Some examples of website content, particularly those including entry forms are provided hereinafter, at FIGS. 24-25. With continued reference to FIG. 8, further depicted is a display 804 to provide an indication of incentives available for an affiliate merchant, though no such incentive is provided, as is generally the case for untrusted merchants.

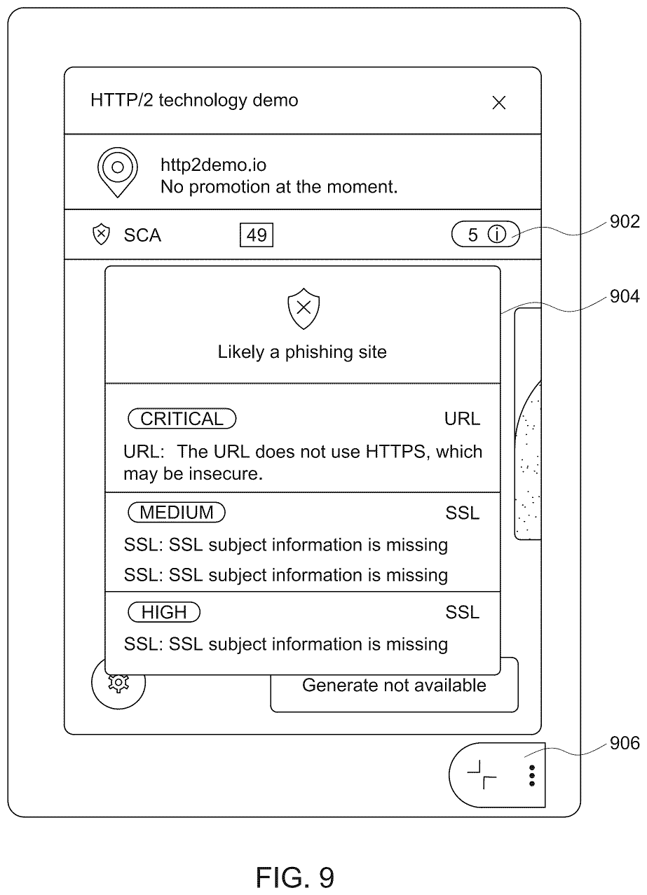

Referring now to FIG. 9, an example of a user interface 110 instance to indicate a restricted host 150 is presented, according to some embodiments. A red badge 902 or other indication of low trust is presented. A control element corresponding to the red badge 902 may be selected, such as by tapping on the badge via a touchscreen, hovering over the badge or clicking the badge with a mouse, etc. Upon selection, a classification detail 904 display is provided. The classification detail 904 can provide an indication that the site is classified as a likely phishing site (or another malicious actor). The classification detail 904 can provide reasons for non-trust (e.g., flags, constituent risk scores, or other contributions). For example, the classification detail 904 can include an indication of the use of HTTP rather than HTTPS, absent issuer information for an SSL certificate, or absent SSL subject information. A further control element 906 (e.g., to access a root menu of a browser plugin or applet, or to access a browser menu for a secure communications application 102 integral to a web browser 108).

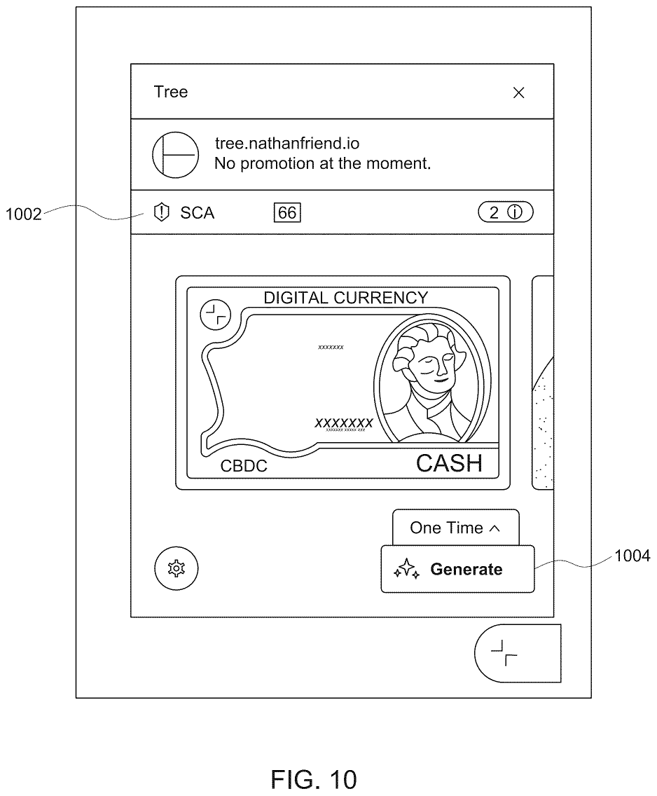

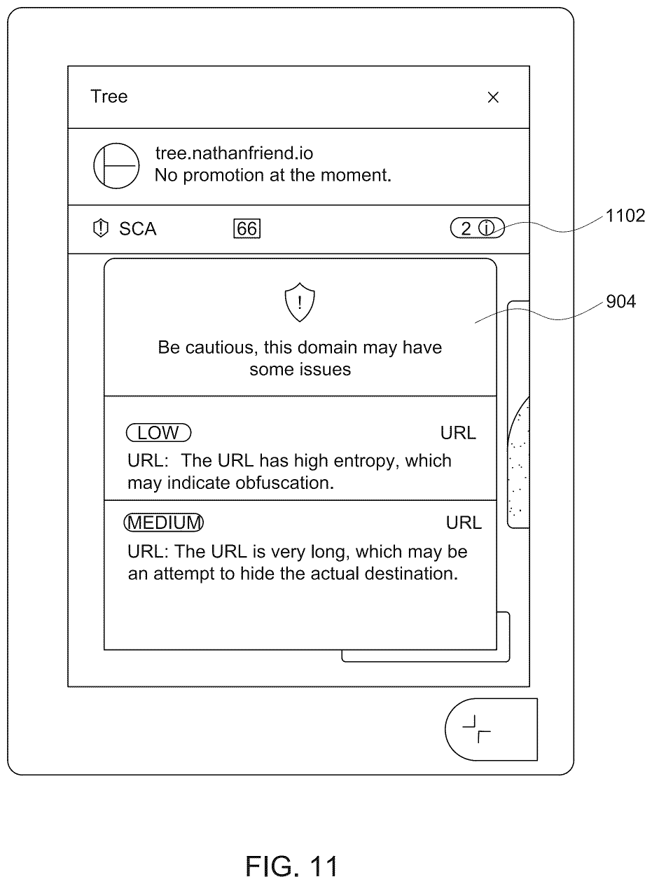

Referring now to FIG. 10, an example of a user interface 110 instance to indicate a restricted host 150 is presented, according to some embodiments. Although classified as a restricted host 150, the system can determine a risk score 1002 indicating greater trust than per FIGS. 8-9. (e.g., a score of sixty-six rather than twenty-four or forty-nine). Accordingly, the secure communications application 102 can cause a display of a control element 1004 to generate a credential, though the control element 1004 may be limited to, or default to, generate a limited use credentials, such as a one time use credential, a transaction limited or time limited credential, or so forth. As is depicted in FIG. 11, a moderate risk indication, such as an amber badge 1102 may be presented, corresponding to another detail view indicating a classification detail 904 for the moderate risk. For example, a long and entropic URL can indicate potential obfuscation.

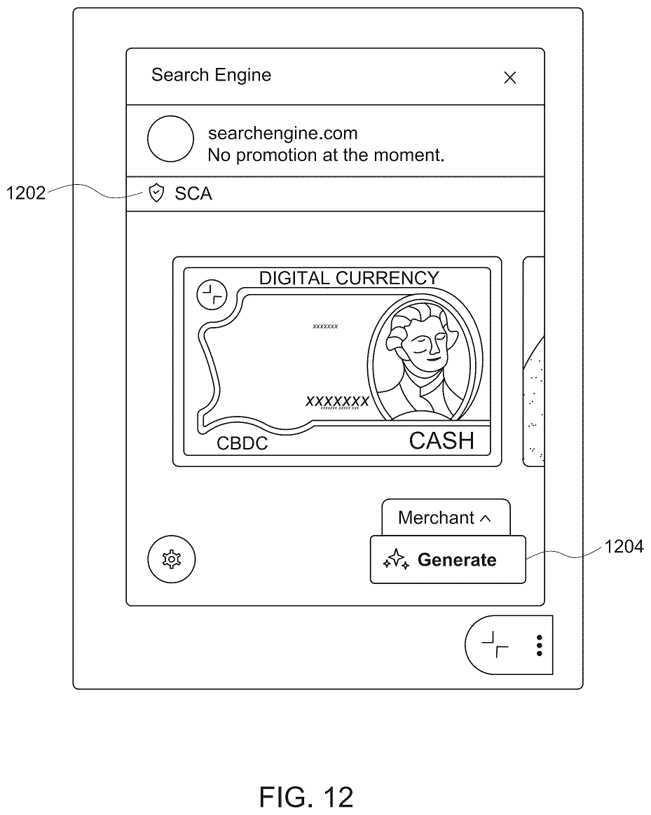

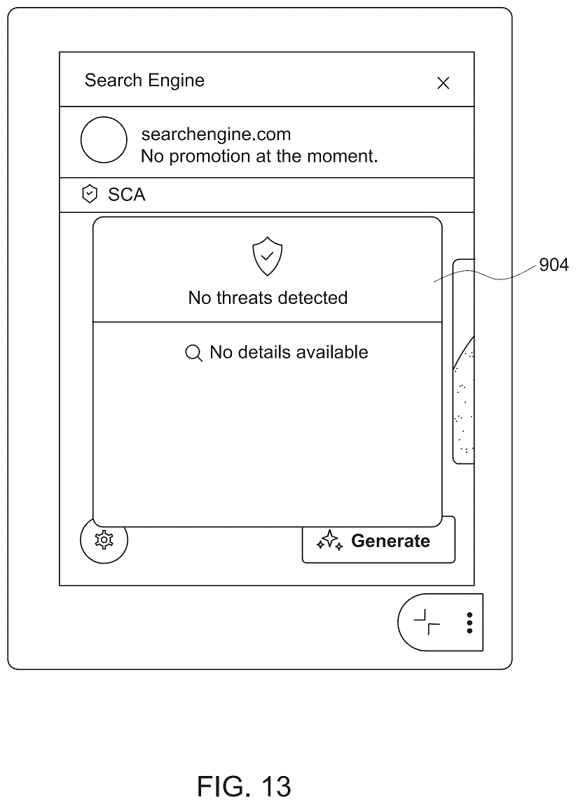

Referring now to FIG. 12, an example of a user interface 110 instance to indicate a permitted host 154 is presented, according to some embodiments. A low-risk indication (e.g., a green badge 1202, as is depicted in FIG. 13) can be presented, corresponding to a classification detail 904 indicating few or no indicia of risk. Referring back to FIG. 11, another control element 1204 can be provided according to a merchant mode, wherein a payment information is tokenized encoding to the merchant (e.g. combining with merchant ID of the merchant-of-record) so as to limit the use of the payment to the merchant. This may be selected as a first choice when detected on an affiliated merchant, and thus can also present incentives associated with website activities, payment cards, or so forth.

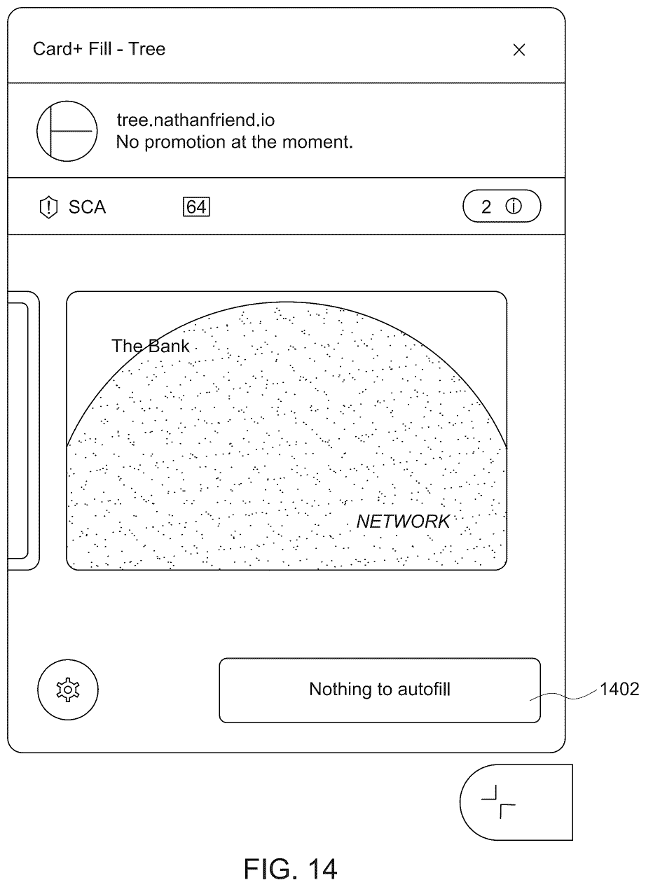

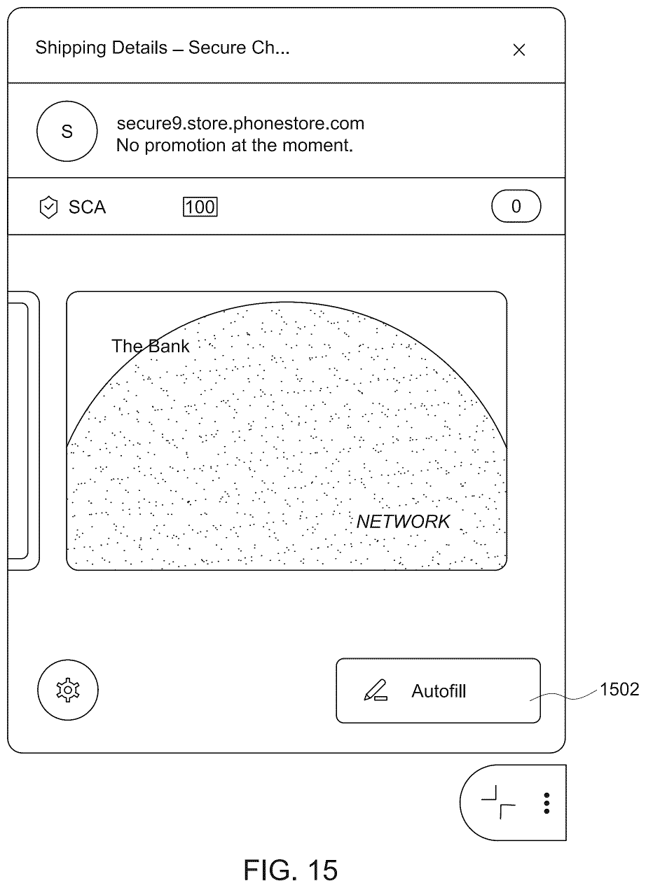

Referring now to FIG. 14, an example of a user interface 110 instance to indicate a host is presented, according to some embodiments. Such an indication can be provided for either of a restricted host 150, unrecognized host 152, or permitted host 154. For example, where no autofill inputs are supported, an indication 1402 of such may be presented. Referring to FIG. 15, where no entry fields for payment cards (or other credentials as may be generated by the secure communications application 102) are present, the secure communications application 102 can cause the user interface 110 to display an indication 1502 that autofill is available (for names, addresses, or so forth), but that no field is recognized for a credential.

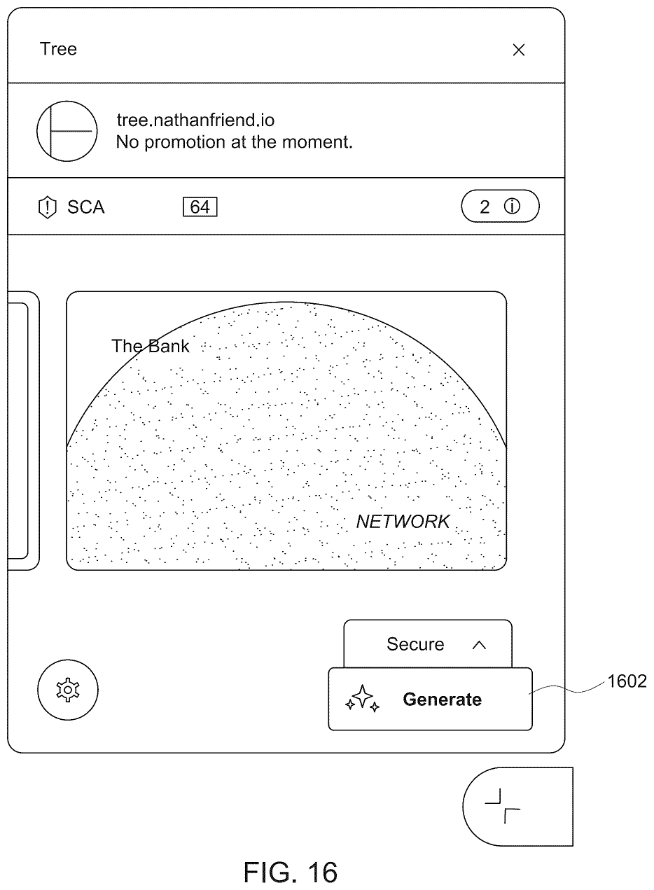

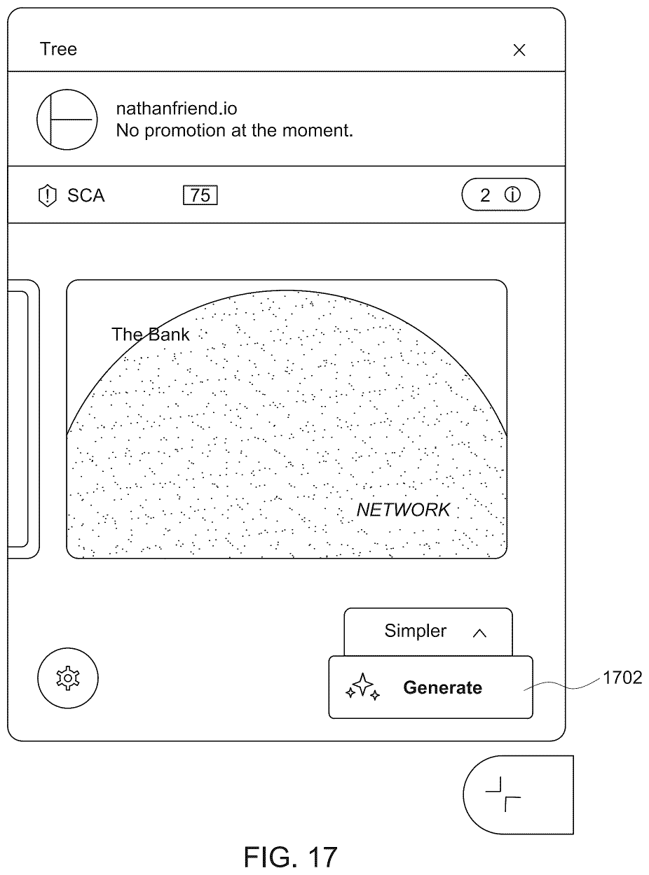

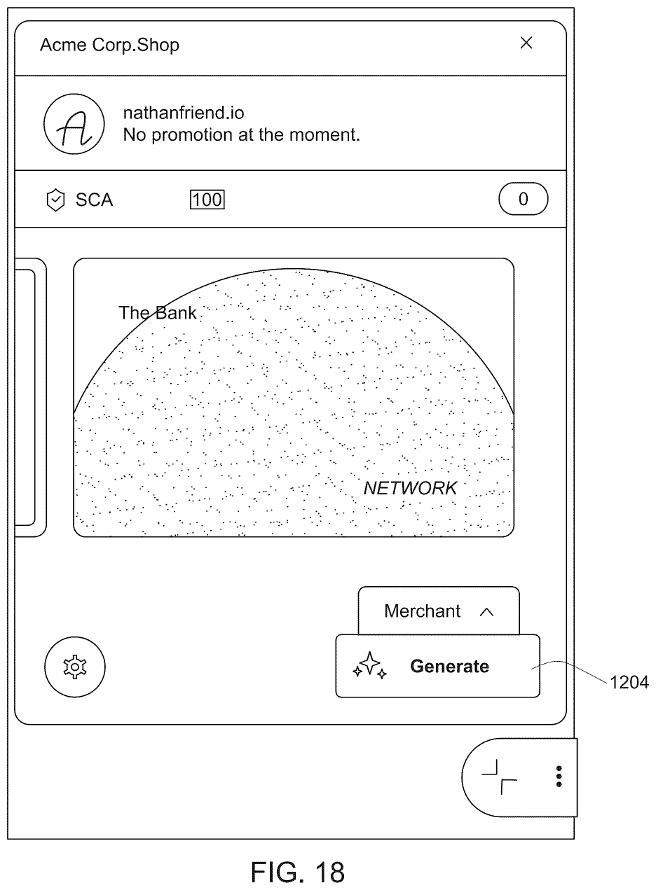

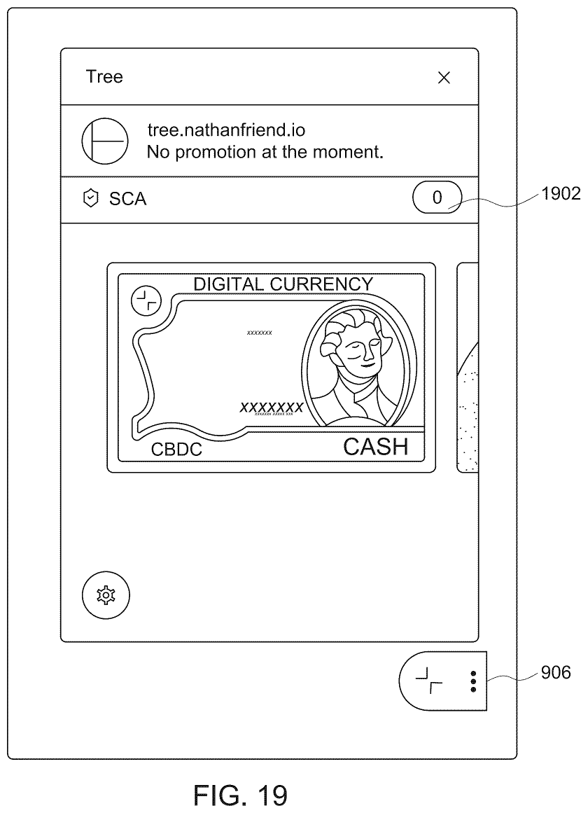

Referring generally to FIGS. 16-19, some example control elements are provided for various host scores. For example, for a moderate-risk tranche of hosts (e.g., for scores between sixty and seventy), a control element 1602 of a “more secure” one-time secure credential in which case a) more of the elements of the payment information may be dynamically generated than b) a less secure (but more conveniently used) method that retains more static elements (e.g., as may be provided as a limited use credential) is provided at FIG. 16. For another moderate-risk tranche of hosts (e.g., for scores between seventy and eighty), a control element 1702 of a one-time secure credential (e.g., as may be provided as a limited use credential, according to fewer restrictions than the control element 1602 of FIG. 16) is provided at FIG. 17. For a low-risk tranche of hosts (e.g., for scores of one hundred), a control element 1204 for a merchant mode can be provided, as depicted at FIG. 18. Such a provision may ease a transaction, such as by allowing the merchant to retain an unmasked payment credential on file, or otherwise identify any incentives available to a user. FIG. 19 depicts an example of a “loading screen” to communicate to a user that a check is in progress. In some embodiments, the “loading screen” may timeout after a predefined period and omit an operation, such as by continuing an off-line mode. More particularly, a score indication 1902 is provided as absent, while a further control element 906 may be accessible to allow manual sections of a user (e.g., to autofill, generate credentials, or so forth).

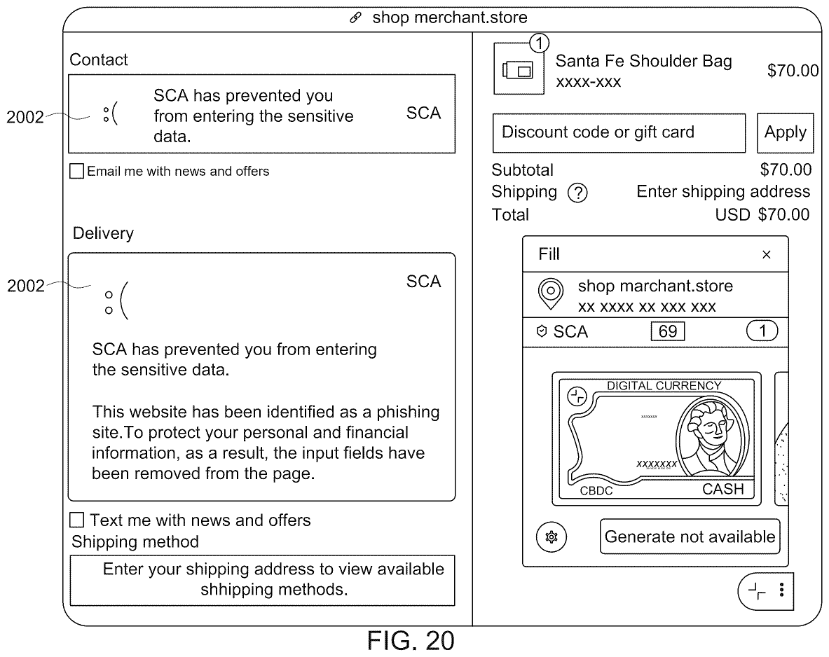

Referring now to FIG. 20, an example user interface 110 instance of a web browser 108 is provided, including blocked entry fields. Such blockage may be performed via an overlay 2002 or by the browser, and the blockage can include bocking an auto-population function, as well as manual entry of the (non-visible) entry fields. For comparison, corresponding unblocked entry fields are depicted henceforth at FIGS. 24-25.

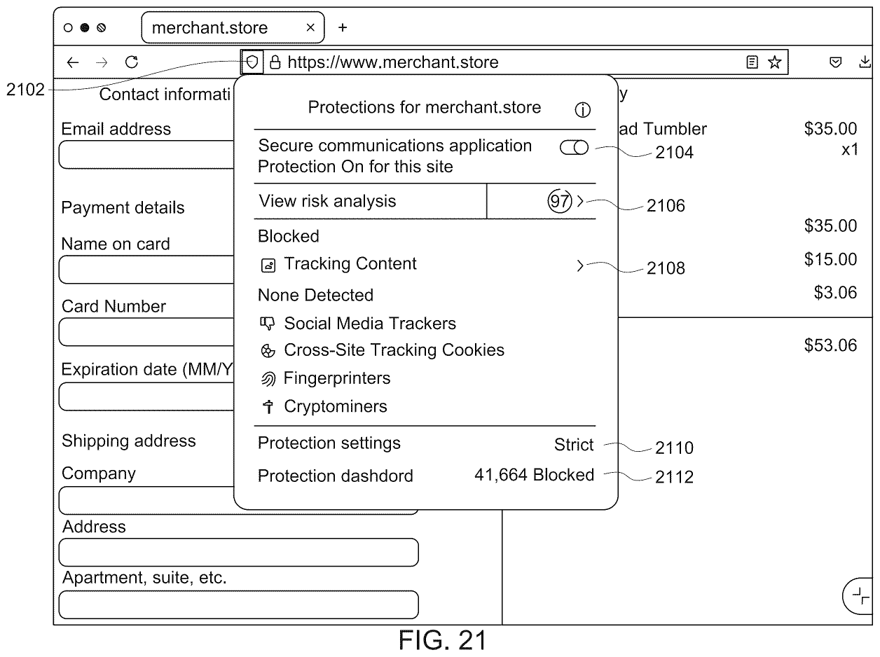

Referring now to FIG. 21, an example menu of a secure communications application 102, as integrated into a web browser 108 is provided, according to some embodiments. A first control element 2102 may indicate a status of the secure communications application 102, or a risk-level associated with a host (e.g., a web page corresponding to the host). The first control element 2102 may be selectable to display further data, or further data may be otherwise selected via the user interface 110. The further data can include, for example, a control element 2104 to activate or deactivate the secure communications application 102, a level of risk 2106 of a website, domain, host, etc., which may be selectable to provide a detail view. The further data can include a configured level of protections 2110 settings, which may be individually configurable (e.g., tracking content 2108). The further data also includes an indication 2112 of blocked entry fields or other elements of web pages (e.g., scripts, pop-ups, etc.).

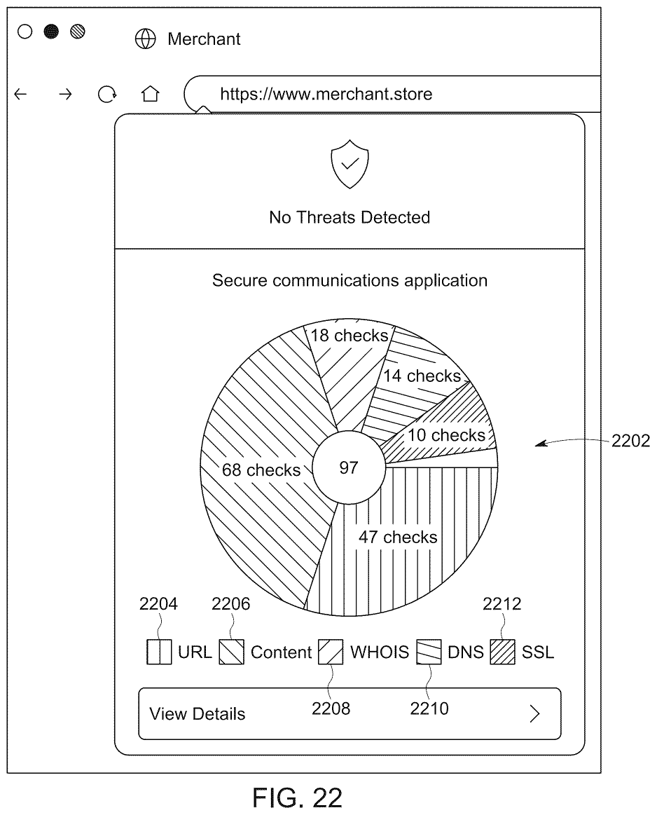

Referring now to FIG. 22, an indication 2202 of passed and failed checks for a host or domain are provided. For example, the included checks can include URL checks 2204, content checks 2206, WHOIS checks 2208, DNS checks 2210, or SSL/Certificate checks 2212. The checks can correspond to deterministic checks of a risk engine 104 or further checks as may be conducted according to an execution of a machine learning model 106, which may be deterministic or non-deterministic, according to varying implementations of the present disclosure.

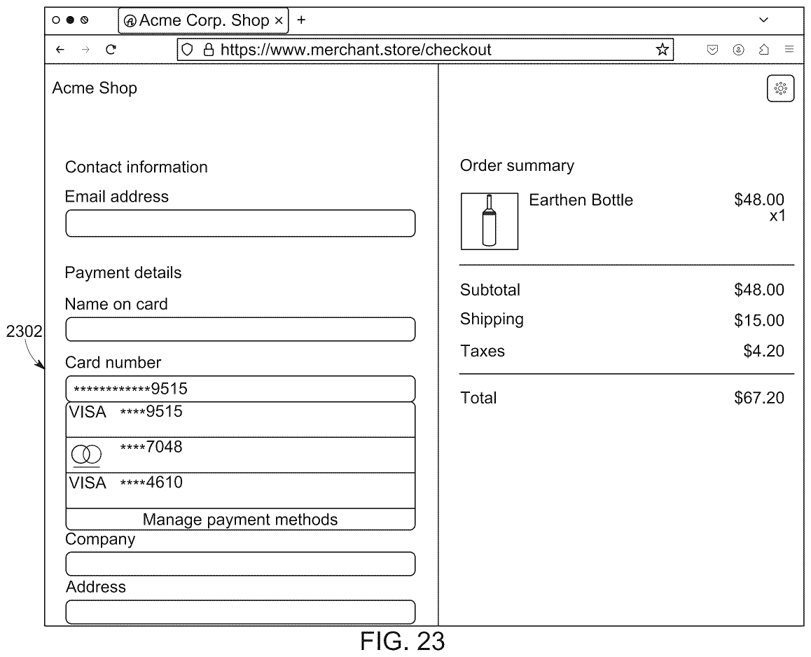

Referring now to FIG. 23, an example user interface 110 instance of a web browser 108 is provided, for a low-risk host. The various entry fields 2302 are presented to a user, and the secure communications application 102 is configured to cause the browser to auto-populate the entry fields 2302. Such fields may be blocked for a higher risk site, or auto-population functions may be inactivated by the secure communications application 102. Further, for the low-risk host, as is depicted in FIG. 24, a control element 1204 can be provided according to a merchant mode, to allow the generation of payment card or other credentials. As is depicted at FIG. 25, the secure communications application 102 can generate a credential 2502 and populate the entry fields 2302 with the credential, along with associated data, such as name, physical address, billing address, email, etc.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively, or in addition-to, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a secure element, a SIM card, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a subject can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

What is claimed is:

1. A method of secure communication comprising:
storing, by one or more processors of a local host, a data structure in a first application, the data structure comprising a plurality of known remote hosts, and a machine learned set of a weighted connections between common features and identifications of known remote hosts;
executing, by the one or more processors, a second application to present a web page comprising one or more entry fields; and
executing, by the one or more processors, the first application to:
identify, by one or more processors, a uniform resource identifier (URI);
generate, by the one or more processors using the URI, a plurality of first features, the plurality of first features comprising an identity of a remote host of the web page;
compare, by the one or more processors, the identity of the remote host to the identifications of the plurality of known remote hosts, to determine whether the remote host matches one of the features or identifications of the plurality of known remote hosts;
responsive to determining a degree of similarity to which the remote host matches the plurality of known remote hosts, infer, by the one or more processors from the machine learned set, using the plurality of first features to generate a risk score of the remote host of the web page, using a machine learning model trained based on:
first tagged web pages for spoofed sites;
second tagged web pages for authentic sites; and
a set of labeled attributes of remote hosts or web pages;
determine, based on the risk score, an appropriate method of a generation for a dynamically generated data element of said one or more entry fields and combine said dynamically generated data element with other static data elements, into a combined data structure capable of auto-population; and
restrict, by the one or more processors, an auto-population with said combined data structure of the one or more entry fields with the set of labeled attributes from the first application, based on the risk score.

2. The method of claim 1, wherein the remote host matches at least one of the plurality of known remote hosts, the known remote hosts being ranked in known risk degrees from low risk to high risk, and further comprising:
ranking, by the one or more processors, a list of credentials associated with the plurality of known remote hosts;
selecting, by the one or more processors, a highest ranked one of the list of credentials; and
generating, by the one or more processors, a symbolic-token to convey the selected one of the list of credentials to the local host.

3. The method of claim 2, wherein:
the list of credentials corresponds to a list of stored accounts; and
the ranking of the list of credentials is based on an incentive of a merchant associated with the remote host.

4. The method of claim 2, wherein an authorization level of the symbolic-token is based on the risk score.

5. The method of claim 1, further comprising:
establishing, by the one or more processors, a communicative connection with a plurality of remote resources;
generating, by the one or more processors, a plurality of second features of the remote host responsive to information retrieved from the plurality of remote resources; and
generating, by the one or more processors, a plurality of third features of content served by the remote host, wherein the restriction is based on the plurality of second features or the plurality of third features.

6. The method of claim 5, wherein generating the plurality of third features comprises:
identifying, by the one or more processors, an image file served by the remote host;
identifying, by the one or more processors, textual content of the image file; and
determining, by the one or more processors based on the textual content, that the remote host is spoofing or otherwise illegitimately misrepresenting itself as one of the known remote hosts, wherein the restriction is configured to present, at the local host, at least one of a set of responses comprising one or more of:
a warning dialog rendered in a user interface of said local host,
a selection of an information generation method of data prior to a data entry operation,
a prevention of an automated entry of the data into the one or more entry fields, or
a prevention of all entries of data into the one or more entry fields.

7. The method of claim 5, further comprising:
generating a second risk score based on the second plurality of features and the plurality of third features, wherein the restriction is based on a comparison of the risk score to a threshold; and
presenting a visual indication of the second risk score.

8. The method of claim 1, wherein the plurality of first features further comprises:
an indication of a secure connection with the remote host via a secure transport protocol.

9. The method of claim 1, wherein the restriction comprises:
disabling automatic completion of the one or more entry fields by the local host.

10. The method of claim 1, wherein the restriction comprises:
masking a display of the one or more entry fields with an overlay indicating a risk score associated with the remote host.

11. The method of claim 1, wherein:
the first application is a microservice; and
the second application is one of a browser or a mobile application, the microservice configured to receive the URI from the second application.

12. A device for secure communications comprising:
an interface connecting a local host to the internet; and
one of more processors coupled with memory and configured to:
store, retrieve, and generate sensitive data elements into a combined data structure in a first application, the sensitive data elements comprising at least one data element with attributes selected from a group of sensitive data attributes comprising one or more of:
personal information,
an employer information,
an identification,
an entitlement,
a financial information,
payment information,
an access credential,
a username;
a password, or
a membership information;
establish a connection with a remote host via said interface;
execute a second application to present a web page received via said interface, the interface configurable to receive sensitive data via at least one data-entry field;
detect a uniform resource identifier (URI) for a remote host potentially configured to receive said data from the at least one data-entry fields;
generate a set of features based on the URI, each element of the set of features based on at least one of:
the URI,
the remote host, or
content received from the remote host;
determine, using a machine learning model, a risk score based on:
said URI,
said remote host,
said content, and
said set of features;
determine, based on the risk score, a type of data generation of at least a portion of said sensitive data, for population in the at least one data-entry field;
based on said risk score, perform an action to populate or decline to populate, at the local host, an entry of the at least one data-entry field with said combined data structure; and
present, via a user interface rendered on said device, a message conveying at least one information element selected from the group comprising one or more of:
the action performed,
a recommendation of an action to be performed,
the risk score, or
a symbolic representation of the action, the recommendation, or the risk score.

13. The device of claim 12, wherein the device is configured to determine:
a first plurality of features of the set of features based on a unique remote host identifier of a URI;
a second plurality of features of the set of features based on information retrieved from a plurality of remote resources of the remote host; and
a third plurality of features of the set of features based on the content served by the remote host, wherein the risk score is based on the first, second, and third pluralities of features.

14. The device of claim 13, wherein the device is configured to:
generate the risk score based on the second plurality of features and the third plurality of features;
present a visual indication of the risk score; and
generate a symbolic-token having an authorization level based on the risk score.

15. The device of claim 12, wherein the combined data structure comprises a plurality of known remote hosts and the device is configured to:
determine whether the remote host matches one of a plurality of known remote hosts;
cause to be populated, responsive to the determination of the match, the at least one data-entry field; and
generate the set of features responsive to a determination that the remote host does not match any of the plurality of known remote hosts.

16. The device of claim 15, wherein the device is configured to:
rank a list of credentials corresponding to a list of stored accounts associated with the remote host;
select a highest ranked one of the credentials; and
automatically populate the at least one data-entry field with a symbolic-token to convey the selected one of the credentials to the remote host.

17. The device of claim 15, wherein the plurality of known remote hosts comprises an approve list and a deny list, wherein the one or more processors are configured to:
determine whether the remote host matches one of the known remote hosts of the deny list; and
inhibit, based on the match to the deny list, the population of the at least one data-entry field based on the determination that the remote host matches the one of the known remote hosts of the deny list.

18. The device of claim 12, wherein the device is configured to operate in an online mode and a local mode, wherein:
when operating in the online mode, the set of features comprises information retrieved from a plurality of remote resources, the information comprising:
a domain registration score for domain registration data,
a domain name score for domain name system data,
a security certificate score for a certificate securing online data communication, and
a content score for a portion of the content disposed proximal to the at least one data-entry field, wherein the content score is predicted according to execution of a machine learning model trained with tagged instances of web pages for spoofed sites and authentic sites.

19. A computer-readable medium having stored thereon instructions that, when executed by a processor, cause the processor to perform a method comprising:
instantiating a web browser configured to access at least one data structure selected from a group of sensitive-attribute data structures, the group comprising one or more of:
personal information,
an identification,
financial information,
payment information,
an access credential,
a username,
a password, or
a membership information; and
presenting web pages comprising one or more data-entry fields on a user device based on a receipt of a uniform resource identifier (URI), wherein the web browser is configured to:
generate, using the URI, a plurality of first features, the plurality of first features comprising an identity of a remote host of a web page;
compare the identity of the remote host to a plurality of known remote hosts, to identify whether the remote host matches one of a first subset of trusted remote hosts of the known remote hosts or one of a second subset of untrusted remote hosts of the known remote hosts;
restrict, based on the identification of the match between the remote remote host and one of the second subset of untrusted remote hosts, an auto-population of the one or more data-entry fields with one or more of the group of sensitive-attributes; and
permit, based on the identification of the match between the remote host and one of the subset of trusted remote hosts, an auto-population of the one or more data-entry fields with one or more of the group of sensitive-attributes.

20. The computer-readable medium of claim 19, wherein the instructions comprise instructions to:
establish a secure connection with a second remote host, the second remote host disposed remote from the computer-readable medium;
generate network traffic to a third remote host, the third remote host configured to identify a source of the network traffic;
determine a presence or an absence of an intermediary disposed between the user device and the third host based on tuple information of the network traffic; and
transmit, to the second remote host, first data based on stored user credentials and the absence of the intermediary.
